(19) United States
(12) Patent Application Publication
(10) Pub. No.: US 2004/0244824 A1
(43) Pub. Date: Dec. 9, 2004

(54) Washing system, ultrasonic washer, vacuum dryer, washing device, washing tank, dryng tank, and production system

(76) Inventors: Kazuyoshi Yasukawa, Nagano (JP); Haruhiro Tsuneta, Nagano (JP); Kazuhide Koike, Nagano (JP); Yuki Nakamura, Nagano (JP); Shiro Sato, Nagano (JP); Noburo Ueno, Nagano (JP)

Correspondence Address: NOTARO AND MICHALOS, 100 DUTCH HILL ROAD, SUITE 110, ORANGEBURG, NY, 10962-2100, US

(21) Appl. No.: 10/487,647

(22) PCT Filed: Aug. 28, 2002
(86) PCT No.: PCT/JP02/08689

(51) Int. Cl. B08B 3/00

(52) U.S. Cl. 134/66; 134/184; 134/902

(57) ABSTRACT

A cleansing system for automatically cleansing a workpiece through cleansing tanks and drying tanks in steps to process and assemble the workpiece, an ultrasonic cleansing apparatus, a vacuum drying apparatus, a cleansing apparatus, a cleansing tank, a drying tank and a production system. For example, a descending air current with a sufficient wind velocity/air capacity is obtained, a cleansing time is reduced and unevenness in cleansing of the workpiece is suppressed without bringing contaminations in a preceding tank into a following tank. The present invention has a carriage device (21) which carries a workpiece (2) to a predetermined position, a plurality of workpiece processing portions (23) arranged around the carriage device (21) in a radial pattern, a drive portion which drives the carriage device (21), a workpiece supply portion (25) which supplies the workpiece (2), and a workpiece discharge portion (26) which discharges the workpiece (2). It is preferable that the number of carriage arms (22) of the carriage device (21) for grasping, mounting thereon or sucking the workpiece (2) and carrying it is not less than the number of the workpiece processing portions (23).

### TECHNICAL FIELD

The present invention relates to a cleansing system, an ultrasonic cleansing apparatus, a vacuum drying apparatus, a cleansing apparatus, a cleansing tank, a drying tank and a production system. More particularly, the present invention relates to an improvement in a structure and the like of an apparatus which automatically cleanses a workpiece through cleansing tanks and drying tanks in steps of processing/assembling the workpiece.

### TECHNICAL TERMS

In this specification, a term “oven” means a furnace or a kiln used to perform a heat treatment and the like for heating a workpiece or cooling the same after heating in order to thereafter carry out desired processing (which will be collectively referred to as “heating and the like” hereinafter), e.g., adhesion sealing, or an apparatus having a function complying with such a furnace or a kiln.

In this specification, a phrase “flowing workpieces one by one” means to put workpieces into a workpiece processing portion or the like and discharge them one by one. The number of workpieces to flow is determined as one per step. For example, only one workpiece is caused to flow in one cleansing step.

In this specification, a term “index operation” means an intermittent rotation operation that a circumferential position of a device which rotates, stops and again rotates is calculated and the device is caused to accurately stop at a determined position.

### BACKGROUND ART

As an apparatus which automatically cleanses a workpiece such as a mechanical component in steps of processing, assembling and the like, there has been utilized a cleansing apparatus which moves a workpiece held by an arm from a cleansing tank to a drying tank and performs cleansing/drying, e.g., a so-called rotary type cleansing apparatus that cleansing tanks and drying tanks are arranged in a circular form. The background of such a cleansing apparatus, the cleansing tank and the drying tank, and a cleansing system constituted of such a cleansing apparatus is as follows.

(Cleansing System)

As shown in, e.g., FIG. 47, in a conventional workpiece cleansing system 101, a cleansing target workpiece is mounted on a carrier 103 such as a tray or a basket, and this carrier 103 is sequentially transferred to cleansing tanks 105 with the high cleanliness by a carriage arm 104, thereby performing cleansing. A plurality of cleansing target workpieces are mounted on the carrier 103, and there is usually carried out so-called batch processing in which a plurality of workpieces are collectively cleansed. A cleansing liquid is filled in each tank 105, and supplying means 106 constantly supplies a small quantity of cleansing liquid to each tank 105. As this cleansing system 101, there are two types, i.e., one configured to belch out a descending air current of clean air from an air current generation device 107 provided above the cleansing tanks 105 and one which is not configured to generate a descending air current as shown in FIG. 48.

Further, like a cleansing system 101 shown in FIG. 49, there is a system which carries a workpiece 102 by a carrier 103 composed of a robot and soaks the workpiece 102 in a cleansing liquid by using an elevating mechanism 108 provided to each tank 105.

However, these conventional cleansing systems 101 have the following problems. That is, (1) the workpiece 102 or the carrier 103 moves above the cleansing tanks 105, and contaminations in a preceding cleansing tank 105 are directly brought into a next cleansing tank 105 when the workpiece 102 or the carrier 103 is moved and soaked into the next cleansing tank 105 with the cleansing liquid attached to the workpiece 102 or the carrier being not completely removed. (2) When a descending air current of clean air is belched from the air current generation device 107 toward the cleansing tanks 105, the descending air current blows down to the cleansing tanks 105, and hence the descending air current cannot obtain a sufficient wind speed and air quantity at a position of the workpiece. (3) The number of carriage arms 104 is small and there is a limit in carriage speed, and hence it is not possible to cope with a reduction in a cleansing time. (4) Since a plurality of cleansing target workpieces are mounted on the carrier 103 and they are set randomly, a workpiece cleansed state after cleansing varies widely in accordance with each workpiece and the unevenness in cleansing occurs.

(Ultrasonic Cleansing Apparatus)

There has been utilized an ultrasonic cleansing apparatus which removes contaminations by irradiating a workpiece in a cleansing tank with ultrasonic waves. In ultrasonic cleansing performed in this example, a liquid repeats expansion and compression when ultrasonic waves are transmitted in the liquid as compressional waves, thereby generating cavitation and an interfacial agitation phenomenon. Therefore, this ultrasonic cleansing removes contaminations by utilizing a mechanical agitation phenomenon at this time. In this case, contaminations which are hard to be removed by simple agitation can be rapidly removed by a strong acceleration generated in the liquid by ultrasonic waves and a local impact pressure involved by cavitation.

However, since the ultrasonic cleansing apparatus utilized as an automatic cleansing apparatus performs a cleansing operation in batch processing, the ultrasonic waves acting on each workpiece is not uniform, and contaminations cannot be effectively removed in some cases.

(Vacuum Drying Apparatus)

As an apparatus which automatically cleanses a workpiece such as a mechanical component in steps of processing, assembling and the like, there has been utilized a cleansing apparatus which moves a workpiece as a cleansing target held by an arm from a cleansing tank to a drying tank and performs cleansing/drying. Further, a so-called rotary type cleansing apparatus in which cleansing tanks and drying tanks are arranged in a circular form has been also utilized.

As such a cleansing apparatus, there is one including a vacuum drying apparatus used to more completely dry a cleansed workpiece. The vacuum drying apparatus facilitates a cleansing liquid or the like attached on a workpiece to be completely evaporated by lowering a boiling point of the liquid by drawing air in the vacuum drying tank. For example, a boiling point of a cleansing pure water attached on a workpiece is lowered to approximately 50° C. by performing drawing air in the vacuum drying tank to obtain approximately 80/760 (approximately 10 kPa) of an atmospheric pressure, thereby forming an environment facilitating drying.

However, in such a vacuum drying apparatus, a device or the like to put a lid on each vacuum drying tank is required as well as a device used to bring a workpiece into the vacuum drying tank. Therefore, this apparatus includes a plurality of devices, which is disadvantageous for reducing a size and a cost of the apparatus. Furthermore, in such a vacuum drying apparatus, a lid must be put on the tank after a workpiece is brought into the tank, and the lid must be first removed when taking out a workpiece, which is disadvantageous for reducing a working time.

Moreover, for example, the dust generated when putting a lid on the vacuum drying tank may fall on a workpiece, and the workpiece may be contaminated while advancing to the final drying step.

Additionally, in the above-described vacuum drying apparatus, although a lid member must be horizontally appressed against the vacuum drying tank in order to maintain a degree of vacuum in the tank, it is hard to constantly hold the lid member horizontally, and the lid member may be slightly inclined depending on apparatuses. Although a method of strongly pressing the lid member can be taken in such an apparatus in order to maintain a high degree of adhesion, it is not a preferred method since a pressing force is biased. Further, it is hard to obtain a high degree of vacuum if the lid member cannot be strongly appressed against the tank.

(Cleansing Apparatus)

As an apparatus which automatically cleanses a workpiece such as a mechanical component in steps of processing, assembling and the like, there has been utilized a cleansing apparatus which moves a workpiece held by an arm from a cleansing tank to a drying tank and performs cleansing/drying. Furthermore, there has been also utilized a cleansing apparatus which maintains the cleanliness in an area by supplying clean air into cleansing/drying work areas so as to keep a degree of cleanness of a cleansed workpiece.

However, trying to keep all cleansing/drying work areas in the cleansing apparatus clean requires a large clean air supply apparatus, which results in an increase in size of the entire apparatus. Moreover, keeping all the work areas clean is inferior in efficiency.

(Cleansing Apparatus, Cleansing Tank and Drying Tank)

As an apparatus which automatically cleanses a workpiece such as a mechanical component in steps of processing/assembling, there has been utilized a cleansing apparatus which moves a workpiece held by an arm from a cleansing tank to a drying tank and performs cleansing/drying. Additionally, there has been also utilized a so-called rotary type cleansing apparatus in which cleansing tanks and drying tanks are arranged in a circular form.

However, since cleansing tanks and drying tanks are previously fixed and arranged at predetermined positions in such a cleansing apparatus, steps of cleansing/drying operations cannot be changed, and it is hard to constitute cleansing/drying steps which flexibly cope with characteristics such as a size or a shape of a workpiece.

Further, in such a cleansing apparatus, a drain duct for drainage must be provided on a tank bottom of the cleansing tank, which may be disadvantageous for a reduction in the number of components or in size of the apparatus in some cases.

It is, therefore, an object of the present invention to provide a cleansing system which does not bring contaminations in a preceding tank into a next tank, can obtain a descending air current with a sufficient wind speed/air quantity and reduce a cleansing time. Furthermore, it is another object of the present invention to provide a cleansing system which can suppress unevenness in cleansing of workpieces. Moreover, it is still another object of the present invention to provide an ultrasonic cleansing apparatus which can effectively remove contaminations of a workpiece. Additionally, it is yet another object of the present invention to provide a vacuum drying apparatus which can reduce a size and a cost and shorten an operating time. Further, it is a further object of the present invention to provide a vacuum drying apparatus which readily maintains a degree of adhesion between a lid member and a vacuum drying tank. Furthermore, it is a still further object of the present invention to provide a cleansing apparatus which can efficiently form clean area in cleansing/drying work areas and readily reduce a size thereof. Moreover, it is a yet further object of the present invention to provide a cleansing apparatus, a cleansing tank and a drying tank which can easily change cleansing/drying steps and realize a reduction in the number of components and in size of the apparatus.

### DISCLOSURE OF INVENTION

To achieve this aim, according to the present invention, there is provided a cleansing system comprising: a carriage device which receives/passes a workpiece and carries it to a work position for cleansing or drying; a plurality of workpiece processing portions arranged around the carriage device in a radial pattern; a drive portion which drives the carriage device; a workpiece supply portion which supplies the workpiece; and a workpiece discharge portion which discharges the workpiece, wherein the carriage device has carriage arms which individually grasp, mount thereon or suck each workpiece and carry the workpiece.

According to this cleansing system, workpieces can be caused to flow one by one since the carriage arms individually carry the workpieces, and changes/additions of processes can be readily performed, thereby conducting non-batch processing. Further, since this cleansing system is suitable for cleansing workpieces manufactured by a small-lot production system, i.e., workpieces manufactured by small-quantity and small-lot production in units of 1 to 10 workpieces with respect to a large-quantity and large-lot production in units of, e.g., 100 workpieces like the batch processing or cleansing small workpieces, an inexpensive and small system can be constituted. Furthermore, it is possible to improve the problem that a cleansing liquid is contaminated when contaminations in a preceding tank are brought into a next tank or the cleansing environment problem that a descending air current cannot obtain a sufficient wind speed/air quantity. Moreover, since carriage arms grasp, mount thereon or suck each workpiece to be carried, a holding attitude of the workpiece when cleansed can be maintained constant, irregularities in cleansing state of cleansed workpieces can be resolved, and unevenness in cleansing can be suppressed.

It is preferable that the number of carriage arms in such a cleansing system is not less than the number of workpiece processing portions. When the number of the carriage arms exceeds the number of the workpiece processing portions, a sufficient carriage speed can be assured, thereby shortening a cleansing time.

Moreover, it is preferable that the workpiece processing portion includes a cleansing tank or a drying tank for workpieces. In this case, the workpieces can be cleansed or dried by the workpiece processing portion which is the cleansing tank or the drying tank.

Additionally, it is preferable that the cleansing system causes a clean descending air current to flow through the entire system including the workpiece processing portions, and has a part in which the descending air current can linearly flow down to a lower portion of the system being provided in the vicinity of a cleansed workpiece discharge portion. As a result, the dust generated in the system can be discharged to the lower portion of the system without again adhering to workpieces, and the cleanliness of workpieces can be maintained.

Further, it is preferable that the cleansing system has a carriage portion to which each cleansed workpiece is carried and that a linear air current path is assured to the lowermost portion of the system in such a manner that the descending air current can linearly flow down in the carriage portion. In such a case, since the descending air current acts on each workpiece passing through the carriage portion, contaminations in a preceding workpiece processing portion can be prevented from being brought into a next workpiece processing portion when carrying the workpiece to the next workpiece processing portion. Furthermore, since the descending air current does not flow down onto the workpiece processing portions, the clean descending air current with a sufficient wind speed/air quantity can be obtained at each workpiece position.

Moreover, it is preferable that a carriage device in the cleansing system inserts a workpiece into each workpiece processing portion in the horizontal direction by expanding/contracting the carriage arm. In this case, since the carriage arm which can be a dust generation source is not provided above the workpieces, thereby assuring the cleanliness of the workpieces.

Additionally, it is preferable that the carriage arms in the cleansing system can be individually or all simultaneously expanded/contracted slightly. Since this cleansing system is capable of slight expansion/contraction, each workpiece can be moved to an arbitrary position within a movable range of the carriage arms. Further, according to this cleansing system, a carriage speed can be increased, and a cleansing time can be reduced.

Further, it is preferable that the carriage device of the cleansing system has a mechanism which moves up and down the carriage arms. According to this cleansing system, each workpiece can be moved to an arbitrary height in each workpiece processing portion.

Furthermore, it is preferable that the workpiece processing portions are configured to be capable of being individually removed and an inner wall on the carriage apparatus side can be manually cleaned. In this case, the individually removed workpiece processing portions can be readily cleaned down to details.

Moreover, it is preferable that the cleansing system can causes fine operations such as rotating and expansion/contraction of a drive portion in each workpiece processing portion, thereby performing even cleansing with respect to the workpiece cleansing apparatus or a cleansing liquid jet. In this case, each workpiece can be more effectively cleansed by addition of the fine operations.

Additionally, in the cleansing system, it is preferable that at least one tank is provided in each workpiece processing portion to hold a cleansing liquid used to cleanse each workpiece in the tank and the cleansing system has a mechanism to give ultrasonic waves to the cleansing liquid by an ultrasonic vibrator provided outside the tank. According to this cleansing system, each workpiece can be soaked in the cleansing liquid in the tank of each workpiece processing portion, and contaminations of each workpiece can be more effectively removed by performing ultrasonic cleansing.

Further, it is preferable that an air nozzle is arranged in each workpiece processing portion and drainage and drying of the workpiece are performed by using air from the air nozzle. According to this cleansing system, drainage and drying of each workpiece can be carried out in a short time by using air from the air nozzle.

Furthermore, it is preferable that the cleansing system has a workpiece processing portion including a heater used to warm a workpiece and a pressure reducing mechanism which reduces a pressure in the workpiece processing portion separately from the above-described workpiece processing portions. According to this cleansing system, since each workpiece can be warmed in a state that a boiling point is lowered by reducing a pressure in the workpiece processing portion, the moisture which has adhered to the workpiece can be readily completely evaporated.

Moreover, the present inventors have examined the ultrasonic cleansing apparatus in many ways in order to achieve the above-described objects. Ultrasonic waves utilized in the ultrasonic cleansing apparatus are elastic waves which are generally higher than an audio frequency and not less than approximately 10 kHz, and the directivity is keener as a frequency is higher. Additionally, the ultrasonic waves have properties that they are greatly attenuated in air but they are excellently transmitted in water, and characteristics that they can cope with the strong energy with a high frequency and a short acoustic wavelength. Further, having a short wavelength means that forming beam-shaped acoustic waves, concentrating acoustic waves in a narrow part or facilitating creation of short pulses. The present inventors took notice of these characteristics of the ultrasonic waves and repeatedly conducted various studies and experiments. As a result, they discovered that a workpiece in the cleansing tank irradiated with ultrasonic waves under given conditions rotates in a liquid.

Here, a distribution of the ultrasonic waves with which the cleansing tank was irradiated is not necessarily uniform in the tank. For example, a workpiece is directly irradiated with some of the ultrasonic waves, or other ultrasonic waves are reflected on an inner wall of the tank and then the workpiece is irradiated with these ultrasonic waves. Therefore, even if the cleansing tank is kept being irradiated with the ultrasonic waves at a fixed level, a conformation of irradiation varies. For example, a ratio of the ultrasonic waves emitted from the lower side or the periphery varies by changing a position of the workpiece in the cleansing tank. Thus, the bias of the ultrasonic waves with which the workpiece is irradiated can be eliminated by moving the workpiece in the tank, and contaminations in details or contact areas with a cleansing arm can be effectively removed by a complex shape of the ultrasonic waves.

Furthermore, the workpiece can be rotated in the cleansing liquid by moving the workpiece in the tank in this manner and changing how the workpiece is irradiated with the ultrasonic waves, or by appropriately changing a frequency of the ultrasonic waves with which the workpiece is irradiated. In this case, a relative flow velocity of the cleansing liquid with respect to the workpiece is increased, and the cleansing liquid flows into details or contact areas with the cleansing arm. As a result, the cleansing effect is advanced, thereby effectively removing contaminations.

Moreover, when rotating the workpiece in the tank in this manner, a rotational direction and a rotational speed of the workpiece can be controlled by changing a depth of the workpiece and an ultrasonic frequency, thus further advancing the cleansing effect.

The present invention is based on this knowledge and characterized in that a cleansing arm on which a workpiece is mounted is moved in a cleansing tank and the workpiece is rotated by changing a position of the cleansing arm in the cleansing tank in an ultrasonic cleansing apparatus which removes contaminations by irradiating the workpiece in the cleansing tank with ultrasonic waves. According to this ultrasonic cleansing apparatus, the cleansing effect can be advanced by actions that the workpiece is moved and rotated in the tank in order to increase a relative flow velocity of the cleansing liquid and the cleansing liquid is caused to flow into details or contact areas with the cleansing arm, thereby effectively removing contaminations.

Additionally, the present invention is characterized in that a cleansing arm on which a workpiece is mounted is moved into a cleansing tank and the workpiece is rotated by changing an ultrasonic frequency in an ultrasonic cleansing apparatus which removes contaminations by irradiating the workpiece in the cleansing tank with ultrasonic waves. According to this ultrasonic cleansing apparatus, the cleansing effect can be advanced by actions that the cleansing arm on which the workpiece is mounted is moved into the cleansing tank, the workpiece is rotated by changing an ultrasonic frequency in order to increase a relative flow velocity of the cleansing liquid and the cleansing liquid is caused to flow into details or contact areas with the cleansing arm, thereby effectively removing contaminations.

Further, in an ultrasonic cleansing apparatus which removes contaminations by irradiating a workpiece with ultrasonic waves, the present invention is characterized in that a rotational direction and a rotational speed of the workpiece are controlled by changing a depth of the workpiece in the cleansing tank and an ultrasonic frequency. According to this ultrasonic cleansing apparatus, the cleansing effect can be further advanced by controlling a rotational direction and a rotational speed of the workpiece.

Furthermore, the present inventors performed examinations in many ways and resulted in the invention which can achieve the above-described objects concerning a vacuum drying apparatus. In a vacuum drying apparatus which moves a cleansed workpiece into a vacuum drying tank and performs drawing air in a sealed state and dries the workpiece, the present invention has a structure that a lid member of the vacuum drying tank is provided above a workpiece holding position of a workpiece holding device which holds a workpiece and takes it in and out to/from the vacuum drying tank and a lid of the vacuum drying tank is closed simultaneously with insertion of the workpiece into the vacuum drying tank. According to this vacuum drying apparatus, since the lid of the vacuum drying tank is provided in the middle of the workpiece holding device, the lid can be put on the vacuum tank simultaneously with inserting the workpiece into the vacuum drying tank and carrying it to a predetermined depth. Therefore, the lid does not have to be again put after carrying the workpiece into the tank, thereby shortening a working time. Moreover, since a device to attach/remove the lid member does not have to be additionally provided, a reduction in size and cost can be achieved.

It is preferable for the vacuum drying apparatus that a support device which supports the vacuum drying tank in the inclinable manner is provided and the vacuum drying tank can follow up the lid member so as to be appressed against the lid member when the lid member is pressed against the vacuum drying tank. In this case, the vacuum drying tank itself supported in the inclinable manner changes its inclination so as to follow up an inclination of the lid member and perform swinging, and absorbs an inclination difference. Therefore, even if the lid member and the vacuum drying tank are not parallel with each other before the lid member is appressed, automatic modification can be carried out so as to incline the vacuum drying tank to match with an inclination of the lid member by pressing the lid member against the vacuum drying tank. In this case, since the high degree of adhesion can be assured by just lightly pressing the lid member, the lid member does not have to be strongly pressed against the vacuum drying tank, and hence the burden on the workpiece holding device can be eliminated.

Additionally, it is preferable for the vacuum drying apparatus that a workpiece mount base which receives the workpiece from the workpiece holding device and mounts it thereon is provided in the vacuum drying tank. In such a case, even if rinsing is attached to a contact area between the workpiece and the workpiece holding device or its periphery, the rinsing can be all readily evaporated.

Further, it is preferable for the vacuum drying apparatus to include a heater which heats the workpiece mount base. According to this vacuum drying apparatus, rinsing and the like attached on the surface can be evaporated and dried by heating a workpiece mounted on the workpiece mount base from the workpiece holding device.

Furthermore, the present inventors examined about a cleansing apparatus in many ways in order to achieve the above-described objects. Although it is general in the cleansing apparatus that respective adjacent cleansing tanks or drying tanks are partitioned in order to avoid flicks of water, areas outside the tanks are not partitioned at all and the entire areas can be maintained clean. However, in view of maintaining a cleansed/dried workpiece clean, the entire cleansing/drying work areas do not have to be clean, it was revealed that maintaining areas after a given step clean can suffice.

Based on this knowledge, according to the present invention, there is provided a cleansing apparatus comprising: a carry-in device which carries in each workpiece; cleansing tanks which cleanse each workpiece; drying tanks which dry each workpiece after cleansing; a carry-out device which takes out each workpiece from the drying tank and carries it out; and a cleansing arm which holds each workpiece carried in by the carry-in device and moves it into the cleansing tanks and the drying tanks, wherein a partition member is set between a carry-in side area and a carry-out side area, and the cleanliness in an area on the carry-out side can be thereby maintained.

When maintaining the cleanliness of a cleansed/dried workpiece, areas before cleansing do not necessarily have to be clean, and it is good enough that areas after at least a given cleansing step (or drying step) are clean. Thus, in the present invention, a predetermined area on the carry-out side is partitioned from the carry-in side by a partition member, and a locally clean area is formed on the carry-out side so that a workpiece after a given step can be maintained clean. According to this cleansing apparatus, a cleansed/dried workpiece can be carried out in the clean state by maintaining the cleanliness in a clean area partitioned by the partition member. In this case, maintaining only the local area clean can suffice, and all the cleansing/drying work areas do not have to be maintained clean. Therefore, the efficiency when forming a clean environment can be improved. Moreover, the clean air supply device does not have to be large in size, thereby readily achieving a reduction in size of the entire apparatus.

Additionally, it is preferable that a notch through which the cleansing arm can pass is provided to the partition member in this cleansing apparatus. For example, when the respective tanks are partitioned to a clean air side and a non-clean air side (which will be referred to as a “general environment area” hereinafter) by the partition member in a rotary type cleansing apparatus in which the respective tanks are arranged in a circular form, although a cleansing arm used to move a workpiece between the respective tanks must move between the both areas, the cleansing arm can move between the both areas through the notch according to this cleansing apparatus. Further, when clean air supplied to the clean area is discharged to the general environment area side through this notch, the dust and the like can be prevented from entering the clean area.

Furthermore, it is preferable for the cleaning device that a clean air supply device which supplies clean air having passed through a filter is provided above the clean area on the carry-out side and the cleanliness in the clean area is kept by maintaining a state that this clean area has a positive pressure as compared with the carry-in side clean area. In this case, it is easy to prevent the dust from entering the clean area.

Moreover, the present inventors conducted various examinations and resulted in the invention which can achieve the above-described objects concerning the cleansing tank and the cleansing apparatus. According to the present invention, a cleansing tank in which a workpiece is soaked and cleansed is provided on the upper end side thereof with a drain portion and a drain pipe for discharging cleansing water. According to this cleansing tank, the cleansing water which overflowed in the cleansing tank can be discharged to another cleansing tank adjacent to this tank through the drain portion and the drain pipe. In this case, the cleansing water in the tank can be further readily convected by reducing a size of the cleansing tank, and contaminations and the like are hard to remain on the bottom of the tank. Therefore, a drain duct does not have to be provided on the bottom of the tank, thereby realizing a reduction in the number of components and size of the apparatus.

Additionally, it is preferable that a plurality of cleansing tanks are provided at different heights, the drain pipe of an upper cleansing tank is inserted into a lower cleansing tank, and the cleansing water in the upper cleansing tank flows into the lower cleansing tank through the drain pipe. According to this cleansing tank, the cleansing water which overflowed in each cleansing tank can be sequentially led to the lower cleansing tanks through the drain pipe and utilized for cleansing in those tanks. Further, by moving each workpiece from the lower tank to the upper tank, it is possible to perform cleansing such that the cleanliness of the cleansing water can be gradually increased.

Furthermore, it is preferable that the cleansing tank has a mount base on which each workpiece is mounted in the tank. In this case, a workpiece carried into the cleansing tank can be set onto the mount base from the workpiece holding arm in the tank. Therefore, contaminations attached to a contact area between the workpiece and a workpiece holding jig and its periphery can be all easily removed.

Moreover, the cleansing apparatus according to the present invention comprises: cleansing tanks defined in claim 26; drying tanks which dry each cleansed workpiece; a carry-in device which carries in each workpiece; a discharge device which discharges each workpiece; and a cleansing arm which holds the carried workpiece, and moves it in the cleansing tanks and the drying tanks and to discharge device. According to this cleansing apparatus, a workpiece which has been carried in can be carried from the cleansing tank to the drying tank by the cleansing arm, and it can be carried out from the cleansing tank after cleansing/drying steps.

Additionally, in the drying tank which dries a cleansed workpiece, the present invention is characterized by comprising a mount base on which a workpiece is mounted in the tank. In this case, a workpiece carried into the drying tank can be again mounted onto the mount base from the workpiece holding arm in the tank. Therefore, the rinsing attached to a contact area between a workpiece and a workpiece holding jig or its periphery can be all readily evaporated.

Further, according to the present invention, there is provided a production system comprising: a plurality of mechanical devices each having a workpiece operation section in which an operation is carried out with respect to a workpiece; devices each of which maintains the workpiece operation section in a clean atmosphere; a carriage device which moves a position of the workpiece in that workpiece operation section; an operation drive device which drives the carriage device and is provided outside the workpiece operation section; and carriage paths which connect the workpiece operation sections of the respective mechanical devices with each other and through which the workpiece is carried from one mechanical device to another mechanical device, wherein one of the mechanical device is the cleansing system defined in claim 1. In this case, it is possible to construct the production system which resolves problems inherent to batch processing, e.g., a reduction in the number of stayed workpieces in the manufacturing process.

### BRIEF DESCRIPTION OF DRAWINGS

FIG. 1 is a plane view showing a production system to which the present invention is applied;

FIG. 2 is a plane view showing an example of an internal structure of workpiece operation sections connected with each other through a carriage tube;

FIG. 3 is a cross-sectional view of the example of the internal structure of the workpiece operation sections connected with each other through the carriage tube, seen from a front side;

FIG. 4 is a plane view showing side walls and a carriage tube with a cover;

FIG. 5 is a plane view showing a structure of the carriage tube from which the side walls and the cover are removed;

FIG. 6 is a plane view of the carriage tube, in which a workpiece mount base is removed and only a linear motor is shown;

FIG. 7A is a plane view showing a structure of the carriage tube with a cover;

FIG. 7B is a front view showing a structure of the carriage tube with a cover;

FIG. 7C is a right-hand side view showing a structure of the carriage tube with the cover;

FIG. 8 is a front view showing the carriage tube provided so as to cut across three mechanical devices;

FIG. 9 is a plane view showing another mode of a production system;

FIG. 10 is a view showing a structural example of a cleansing system including a clean descending air current generation device;

FIG. 11A is a lateral cross-sectional view showing an internal structure of the cleansing system;

FIG. 11B is a vertical cross-sectional view showing an internal structure of the cleansing system;

FIG. 12 is a partial cross-sectional view showing an insertion hole of a workpiece processing portion and a step-shaped carriage arm which has inserted a workpiece from this insertion hole;

FIG. 13 is a partial cross-sectional view showing an example of a shape of a partition wall having a carriage path formed thereto;

FIG. 14 is a partial cross-sectional view of a cleansing system which includes a flowing water jet device and superposes ultrasonic flowing water as a cleansing fluid;

FIG. 15 is a partial cross-sectional view of a cleansing system which changes a direction of the flowing water jet device by a jet angle change mechanism using a linear motor;

FIG. 16 is a partial cross-sectional view of a cleansing system which includes an elevating mechanism such as a linear motor which moves up and down a workpiece cleansing device or a rotation mechanism such as a rotary motor;

FIG. 17 is a partial cross-sectional view of a cleansing system in which a clean hot air jet mechanism is provided to a workpiece processing portion;

FIG. 18 is a partial cross-sectional view of a cleansing system including means for changing a grasping position of a carriage arm with respect to a workpiece;

FIG. 19 is a perspective view of a cleansing system having a structure that workpiece processing portions can be individually removed;

FIG. 20 is a plane view of a carriage arm of a carriage device which finely vibrates or quivers a workpiece;

FIG. 21 is a plane view showing an example of a cleansing system which soaks a workpiece in a cleansing liquid in tanks of workpiece processing portions and cleanses it;

FIG. 22 is a schematic view of a carriage device in a state that a carriage arm has been moved up;

FIG. 23 is a schematic view of the carriage device in a state that the carriage arm has been moved down;

FIG. 24 is a front view of a workpiece processing portion which performs ultrasonic cleansing;

FIG. 25 is a front view of the workpiece processing portion which performs ultrasonic cleansing;

FIG. 26 is a plane view of a workpiece processing portion which performs hot-air drying;

FIG. 27 is a front view of the workpiece processing portion which performs hot-air drying;

FIG. 28 is a plane view of a workpiece processing portion which performs vacuum drying;

FIG. 29 is a front view of the workpiece processing portion which performs vacuum drying;

FIG. 30 is a schematic plane view of a cleansing apparatus showing an embodiment according to the present invention;

FIG. 31 is a perspective view showing an example of structures of a cleansing arm, an arm support shaft and a rotary type cleansing tank;

FIG. 32 is a perspective view of an ultrasonic cleansing apparatus;

FIG. 33 is a model drawing of ultrasonic waves having a frequency of 40 kHz;

FIG. 34 is a model drawing of ultrasonic waves having a frequency of 100 kHz;

FIG. 35 is a perspective view of a vacuum drying apparatus showing an embodiment according to the present invention;

FIG. 36 is a plane view comprehensibly showing a clean area partitioned by a partition member;

FIG. 37 is a vertical cross-sectional view showing an example of a shape of a partition member having a double structure;

FIG. 38 is a lateral cross-sectional view showing the example of the shape of the partition member having the double structure;

FIG. 39 is a perspective view showing an example of a shape of the partition member and an example of installation of a clean air supply device;

FIG. 40 is a view showing an example of a shape of a notch, seen from a general environment area side;

FIG. 41 is a partial front view showing an example of an end structure of a cleansing arm;

FIG. 42 is a perspective view showing an example of shapes of a cruciform workpiece holding jig and a workpiece mount base;

FIG. 43 is a plane view showing the example of shapes of the cruciform workpiece holding jig and the workpiece mount base;

FIG. 44 is a plane view showing an example of shapes of an elongated rectangular workpiece holding jig and a workpiece mount base;

FIG. 45 is a perspective view showing a cleansing tank to which a drain portion and a drain pipe are provided on an upper end side thereof;

FIG. 46 is a view showing an example that three cleansing tanks are arranged at different heights and a state of a convection of cleansing water in the tanks;

FIG. 47 is a perspective view showing a conventional workpiece cleansing system;

FIG. 48 is a perspective view showing the conventional workpiece cleansing system, seen from a front side; and

FIG. 49 is a plane view showing a conventional workpiece cleansing system according to another mode.

### BEST MODES FOR CARRYING OUT OF THE INVENTION

A structure of the present invention will now be described hereinafter in detail based on illustrated best modes.

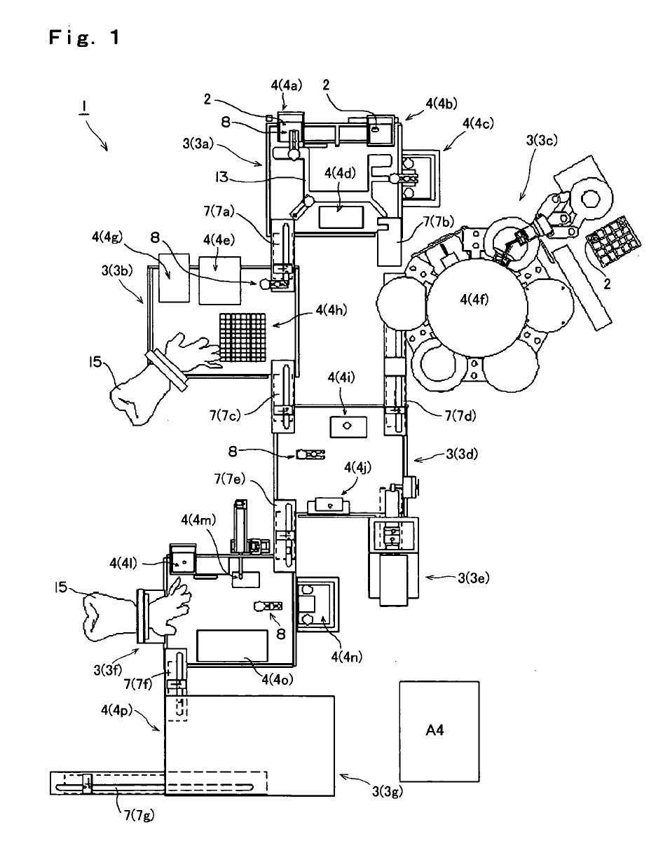

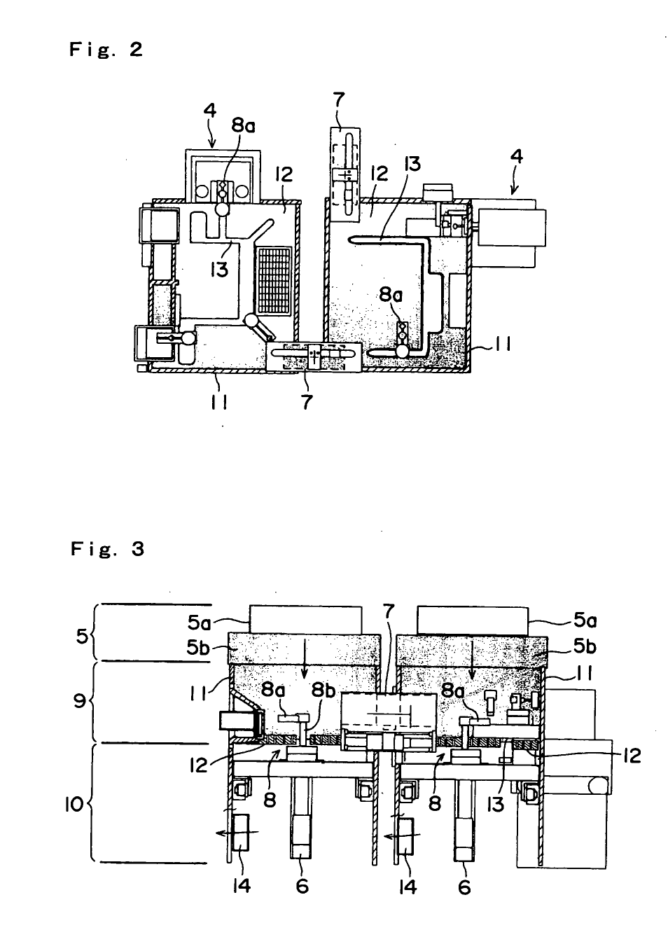

FIGS. 1 to 8 show a production system 1 to which the present invention is applied. The production system 1 includes: a plurality of mechanical devices 3 (denoted by reference numerals 3a to 3g in FIG. 1) having workpiece operation sections 4 (denoted by reference numerals 4a to 4p in FIG. 1) in which operations such as processing, assembling, heating, cleansing and others are carried out with respect to a workpiece 2; devices 5 each of which maintains each workpiece operation section 4 in a clean atmosphere (which will be referred to as a “cleaning device 5” hereinafter); carriage devices 8 each of which moves the workpiece 2 in each workpiece operation section 4; operation drive devices 6 each of which drives the carriage device 8 and is provided outside each workpiece operation section 4; and carriage paths 7 which connect the workpiece operation sections 4 of the respective mechanical devices 3 with each other and carry the workpiece 2 from one mechanical device 3 to another mechanical device 3. It is to be noted that FIG. 1 also shows an A4-size paper sheet (size: 297 mm×210 mm) as a comparison target in order to show a schematic size of the production system 1 in this embodiment.

An embodiment of the production system 1 which produces a dynamic pressure bearing motor will now be described hereinafter. The production system 1 according to this embodiment includes a plurality of mechanical devices 3 denoted by reference numerals 3a to 3g in parentheses. These mechanical devices 3a to 3g are partitioned into three areas, i.e., a clean descending air current generation area composed of the cleaning devices 5, a work area 9 and a mechanism area 10 as shown in FIG. 3, and connected to each other in a state that they are shut off from outside air by a plurality of carriage paths (denoted by reference numerals 7a to 7g in parentheses in FIG. 1). A dynamic pressure bearing motor which is an example of the workpiece 2 or a component constituting this motor is appropriately passed through the carriage paths 7a to 7g and carried between the respective mechanical devices 3a to 3g.

The respective mechanical devices 3a to 3g have a single or a plurality of workpiece operation sections 4 such as a motor shaft supply section 4a which are respectively independent, whose inside is maintained in a clean atmosphere state and which have different functions, in other words, respective operation departments in which processing/assembling of a dynamic pressure bearing motor as the workpiece 2 is performed on an assembly line. It is to be noted that denoting the respective workpiece operation sections 4 by reference numerals 4a to 4p in parentheses in FIG. 1 means that these sections are different from each other. For example, in this embodiment, the mechanical device 3a has a motor shaft supply section 4a, a plate supply section 4b, a shaft press fitting section 4c and a heater section 4d; the mechanical device 3b has a verticality inspection section 4e; the mechanical device 3c has a cylinder cleansing section 4f; the mechanical device 3e has a cylinder inside diameter measuring section 4k; the mechanical device 3f has a bottom adhesion sealing section 4m, a bottom shrink fitting section 4n and a heat section 4o; and the mechanical device 3g has a heating section 4p. Further, a shaft diameter measuring section 4g, a stock section for each frame work/shaft diameter 4h, a corresponding frame work selection section 4i and a shaft insertion section 4j are provided in a space extending from the mechanical device 3a to the mechanical device 3d. In this case, although the respective workpiece operation sections 4 are basically arranged in the longitudinal direction along which the workpiece 2 is carried, an additional operation area may be provided in the lateral direction according to needs. The mechanical device 3c forms a cleansing system as will be described later.

The cleaning device 5 supplies clean air into the work area 9 in the clean descending air current generation area, and maintains the atmosphere in each workpiece operation section 4 in a clean state. For example, in case of the production system 1 according to this embodiment, the cleaning device 5 is constituted of a blower 5a which blows out air and a filter 5b which cleans the blown-out air as shown in FIG. 3, and supplies a descending air current of clean air into the work area 9 so that the work area 9 is managed to be constantly in a positive pressure state (i.e., a state that a positive pressure is obtained) with respect to the outside or the mechanism area 10. Furthermore, there is also provided non-illustrated controlling means which variably adjusts a discharge pressure or a discharge quantity of the blower 5a in order to generate an appropriate clean processing air current.

The work area 9 is, e.g., a work space with a positive pressure which has four side walls 11 and the cleaning device 5 attached to the upper portion thereof, and the dynamic pressure bearing motor is processed/assembled in this space in which the clean atmosphere is maintained. The work area 9 can be reduced in size within a range required to process/assemble the workpiece 2.

On the other hand, the mechanism area 10 has exhaust means 14 and is controlled so as to have a pressure less than that in the work area 9 but more than that of outside air. When a positive pressure above a pressure of outside air is obtained, the power consumption can be reduced by stopping the exhaust means 14 in that period, which is preferable. The mechanism area 10 has a door provided on at least one of the four side walls 11. Moreover, although not shown, a negative pressure source at a position where a possibility of generation of the dust is high at the upper portion of the mechanism area 10 is guided by a tube, and suction is performed.

Partition walls 12 between the work area 9 and the mechanism area 10 are movably provided at parts where the work area 9 has a higher pressure than that of the mechanism area 10 so as to prevent air from entering the work area 9 side from the mechanism area 10 side. Additionally, at any other parts, the work area 9 and the mechanism area 10 are partitioned by walls of, e.g., a grating or a punching metal. Holes are formed to the partition walls 12, and the operation drive device 6, the carriage paths 7 or the carriage devices 8 can be directly or indirectly attached to these holes. Further, when a glove 15 is provided to each hole of the partition walls 12 or the side walls 11, it is possible to provide a function enabling a maintenance/security operation, e.g., manually moving the workpiece 2. Furthermore, slits 13 are formed to the partition walls 12 along a movement path of a shaft portion 8b of each carriage device 8.

The carriage device 8 is formed of a device such as a robot which is installed so as to perform movement/carriage of the workpiece 2 from the outside of each workpiece operation section 4, set in such a manner that at least an operation end 8a such as a tool or a hand can enter the work area 9, and has a structure that this operation end 8a is connected with the operation drive device 6 as a drive source of the carriage device 8 through the shaft portion 8b. This carriage device 8 approaches the workpiece 2 from the outside of the workpiece operation section 4, holds or grabs the workpiece 2 and moves the workpiece 2 in that workpiece operation section 4 or between the workpiece operation section 4 and the carriage paths 7. As the operation end 8a, it is possible to adopt any device which has a function to, e.g., grasp, hang or thrust the workpiece 2 and can move the workpiece 2.

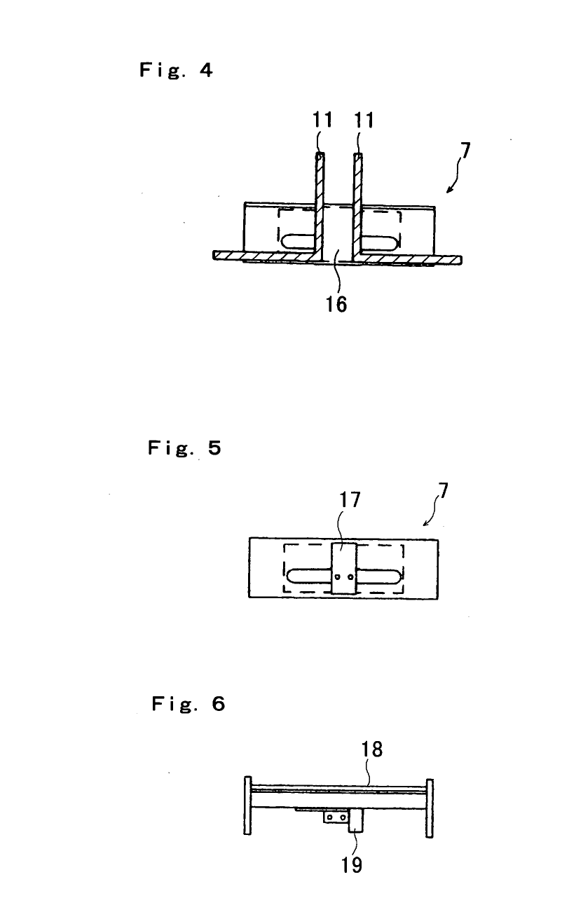

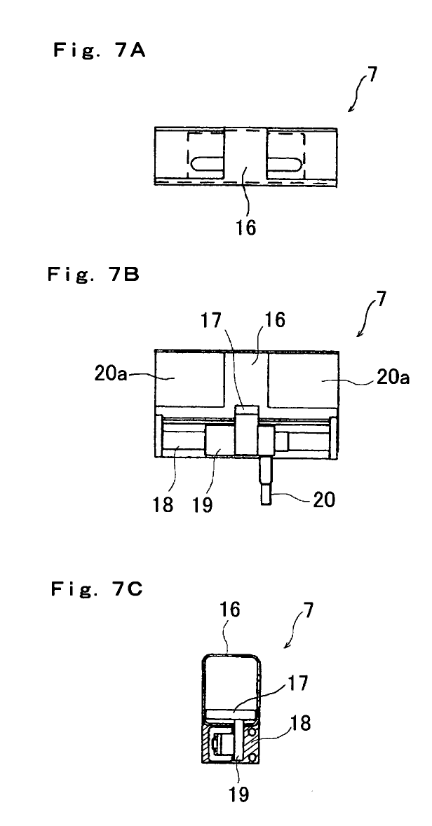

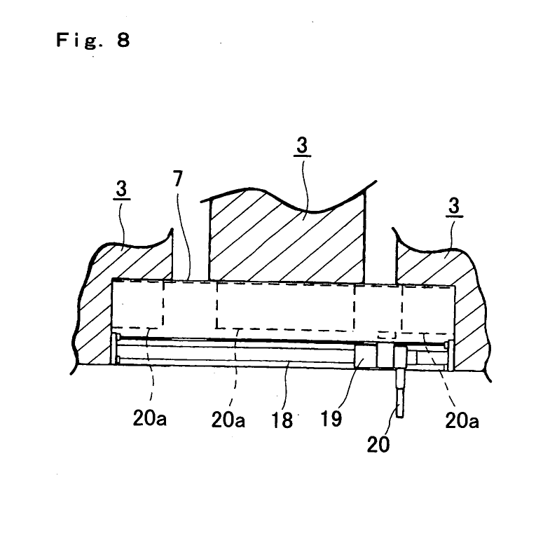

FIGS. 4 to 8 show an example of the carriage path 7. The carriage path 7 is a tube with a cover 16 (which will be referred to as a “carriage tube 7” hereinafter). The carriage tube 7 has an end portion thereof inserted into a part between the work area 9 and the mechanism area 10 and which connects the mechanical device 3 on the upstream side with the mechanical device 3 on the downstream side, and a workpiece mount base 17 is provided on the inner side of the cover 16 as shown in FIG. 5 illustrating a state that the cover 16 is removed. Moreover, a stator 18 and a mover 19 of a linear motor are provided on the lower side of the workpiece mount base 17 as shown in FIG. 6. As shown in FIGS. 7A to 7C, the mover 19 supports the workpiece mount base 17, and linearly moves along the stator 18. Reference numeral 20 denotes a wire which supplies a power to the linear motor, for example. Additionally, a part of the carriage tube 7 without the cover 16 corresponds to a window 20a opened to the inside of the mechanical device 3, and the carriage device 8 can take out the workpiece 2 through this window 20a. Further, FIG. 8 shows a carriage tube 7 which is provided so as to pierce the middle mechanical device 3 and cut across the three mechanical devices 3. A plurality of windows 20a are provided to this carriage tube 7 in accordance with the respective mechanical devices 3. It is to be noted that the inner side of each mechanical device is indicated by hatching only in FIG. 8. It is most preferable that the inside of this carriage tube 7 is maintained in a clean atmosphere and the carriage tube 7 can carry the workpiece 2 in the middle of manufacturing processes from the upstream side mechanical device 3 to the downstream side mechanical device 3 while maintaining the cleanliness. In this case, although an airtight tube which can shut off the work area 9 from outside air is preferable as this carriage tube 7, the dust can be prevented from entering by providing a positive pressure in the work area 9 and thereby venting air through a slit or the like even if perfect air-tightness is not realized because the slit is provided. Furthermore, standardized/normalized joints of the carriage tube 7 are preferable since attachment/detachment can be facilitated. In the production system 1 according to this embodiment, the carriage tubes 7 and the carriage devices 8 constitute a supply/discharge mechanism used to supply and discharge the workpiece 2 to/from the respective workpiece operation sections 4.

When the dynamic pressure bearing motor is manufactured by the above-described production system 1, each unit constituting the dynamic pressure bearing motor, e.g., a motor shaft or a plate is first supplied from a supply opening provided on the side wall 11 of the workpiece operation section 4. Cylinder cleansing of a cylindrical workpiece 2 which can be a motor case is performed by ultrasonic flowing water obtained by superposing ultrasonic waves on cleansing flowing water or scrub cleansing using a brush while appropriately changing a direction of a jet. It is to be noted that chambers themselves in the cylinder cleansing section 4f can be replaced since they are detachable, but the number of the chambers to be installed can be freely determined. Moreover, after shaft press fitting, each motor shaft diameter is measured, and the motor shafts are classified and stocked in accordance with each diameter. Additionally, an inside diameter of each cylinder is measured, and a shaft having an inside diameter which matches with that of the cylinder is selected and inserted into the cylinder. Further, a plate is caulked, and an adhesive is applied to the plate so as to avoid leakage of an oil. After assembling, the adhesive is dissolved by heating, thereby performing adhesion sealing. In this case, a plurality of workpieces (motor components) can be heated at a time by heating them in an oven like this embodiment. Further, one component must be always set in the oven, and a time is notified by a timer. When the heated workpiece 2 is carried from the oven, a next workpiece 2 is set at the end of the line to the oven, thereby increasing the efficiency.

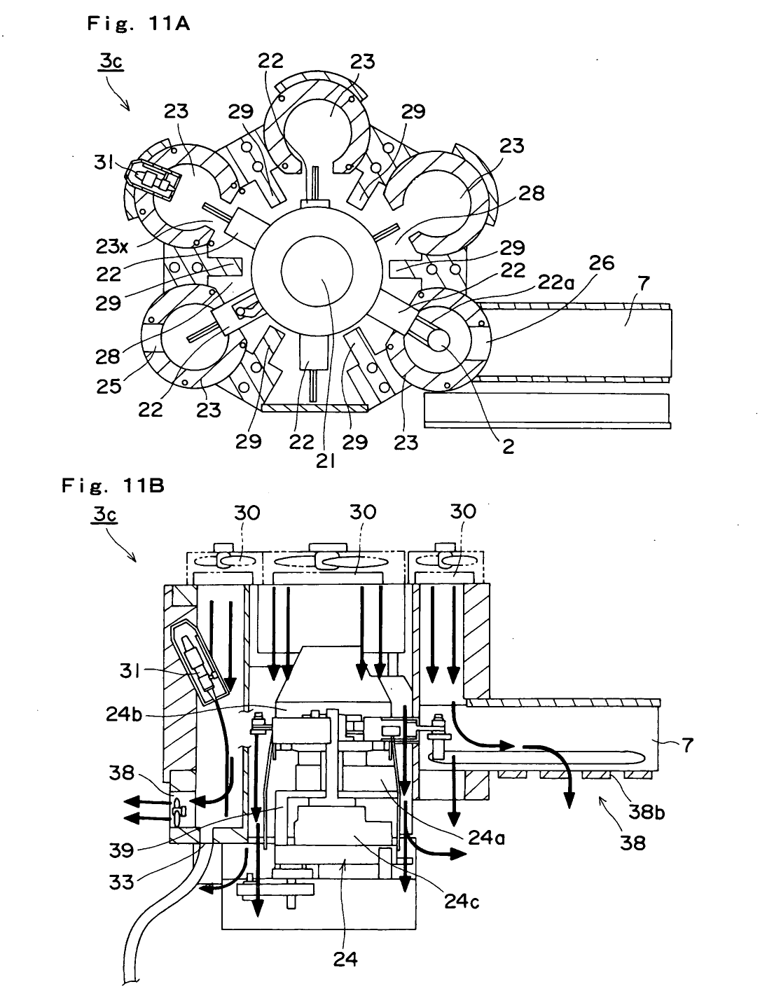

A cleansing system according to the present invention will now be described (see FIGS. 11A to 20). The cleansing system in the production system according to this embodiment is a system formed of the mechanical device 3c which cleanses the workpiece 2 (this mechanical device 3c will be referred to as a “cleansing system 3c” hereinafter), and constitutes a cylinder cleansing section 4f.

The cleansing system 3c has a carriage device 21 which carries the workpiece 2 to a predetermined position, a plurality of workpiece processing portions 23 arranged around this carriage device 21 in a radial pattern, a drive portion 24 which drives the carriage device 21, a workpiece supply portion 25 which supplies the workpiece 2, and a workpiece discharge portion 26 which discharges the workpiece 2. The number of carriage arms 22 which maintain an attitude of the workpiece 2 constant when being held during cleansing by, e.g., grasping, mounting thereon or sucking the workpiece 2 and simultaneously carry the workpiece 2 while increasing a cleansing area as large as possible when holding the workpiece 2 is larger than the number of the workpiece processing portions 23. This embodiment illustrates each carriage arm 22 which grasps one workpiece 2 by a carriage hand 22a as an example. It is to be noted that a plurality of carriage hands 22a which grasp one workpiece 2 may be provided to the carriage arm 22.

Each workpiece processing portion 23 is a cleansing tank or a drying tank for the workpiece 2. It is preferable that the workpiece processing portions 23 are arranged around the carriage device 21 in the circumferential direction at equal intervals. In this case, the drive portion 24 can perform a forward feeding operation at equal angles according to arrangement angles of the workpiece processing portions 23.

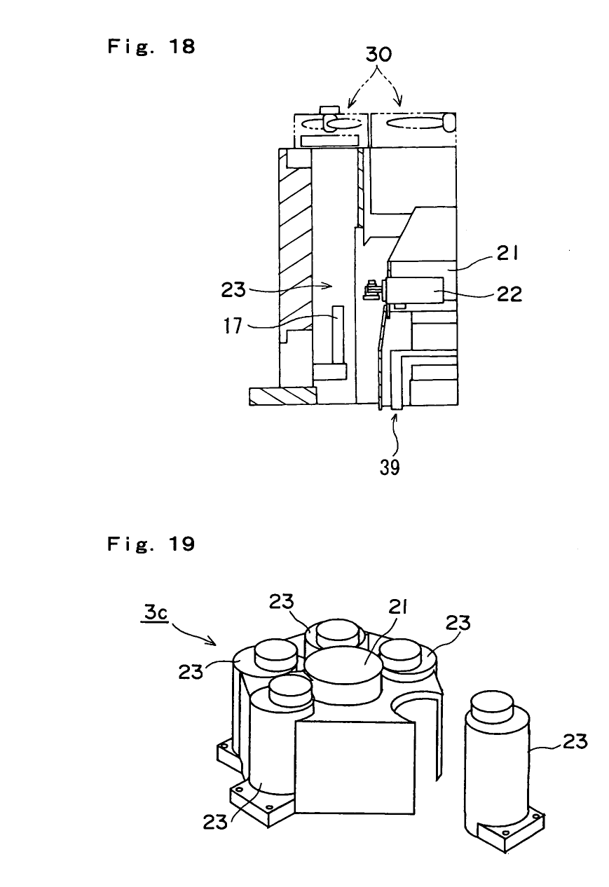

Furthermore, at least one of the workpiece processing portions 23 has a structure that the workpiece 2 can be supplied from the outside of the cleansing system 3c, and at least another workpiece processing portion 23 has a structure that the cleansed workpiece 2 can be discharged to the outside of the cleansing system 3c. For example, in this embodiment, as shown in FIG. 11A, a hole through which the workpiece 2 can be carried in is formed as a workpiece supply portion 25 to the workpiece processing portion 23 which performs the first cleansing, and a hole through which the workpiece 2 can be carried out is formed as a workpiece discharge portion 26 to the workpiece processing portion 23 which effects the last cleansing. Further, each workpiece processing portion 23 has an insertion hole 23x through which the workpiece 2 held by the carriage device 21 is taken in/out, and a device which changes a grasping position of the carriage arm 22 with respect to the workpiece 2 is set as shown in FIG. 18. For example, the grasped workpiece 2 is once put on the workpiece mount base 17, the carriage arm 22 is moved by the mechanism 39 which moves up and down the carriage arm 22, and the workpiece 2 is again grasped. As a result, a workpiece grasping position can be changed, and these devices constitute the device which changes a grasping position. An attachment hole for a component such as a cleansing brush utilized in cleansing or the like is formed on the side surface of each workpiece processing portion 23. The mechanism 39 which moves up and down the carriage arm 22 can be constituted by combining a cam or an actuator such as a motor.

Furthermore, it is preferable that the workpiece processing portion 23 has a structure that an upper component such as a lid component can be removed in the upper direction or the lateral direction and the inner wall can be manually cleaned. The workpiece processing portions 23 according to this embodiment are configured to be capable of individually being removed as shown in FIG. 19, and the inner wall of the workpiece processing portion 23 can be manually cleaned in the removed state.

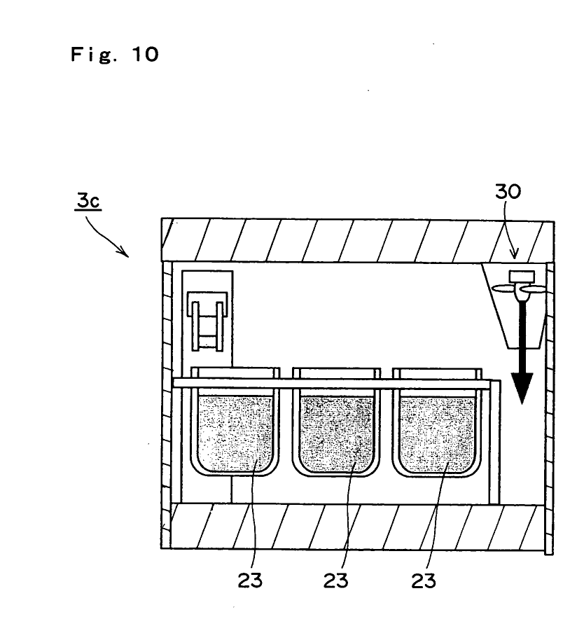

Moreover, it is preferable for the cleansing system 3c that a clean descending air current is caused to flow through the entire system and a descending air current which linearly flows down to the lower portion of the cleansing system 3c is formed in the vicinity of the workpiece discharge portion 26. In this embodiment, as shown in FIGS. 10 and 11B, a clean descending air current generation device 30 formed of a fan, a filter and others is provided at the end in the cleansing system 3c so as to generate a descending air current in the cleansing system 3c. Additionally, the cleansing system 3c according to this embodiment has carriage portions 28 and carriage paths 27 through which the cleansed workpiece 2 is carried, and a linear air current path is assured to the lowermost portion of the system so that the descending air current in the carriage portions 28 can linearly flow down. Therefore, when the workpiece 2 (and the carriage arm 22) moves, contaminations in the workpiece processing portion 23 on a preceding stage are prevented from being brought into the next workpiece processing portion 23.

The drive portion 24 is a member which drives the carriage device 21, and the drive portion 24 according to this embodiment has, e.g., an index actuator 24a which operates the carriage device 21 to rotate, a rotation portion 24b which performs an index operation, and an arm expansion/contraction actuator 24c which expands/contracts the carriage arm 22 as shown in FIGS. 11A and 11B. Here, it is preferable for the drive portion 24 that it can perform an operation at a small angle with respect to a size of the workpiece 2 since the fine positional adjustment is thereby enabled.

The carriage device 21 can insert the workpiece 2 into the workpiece processing portion 23 in the horizontal direction by expanding/contracting the carriage arm 22 (see FIG. 11A), and move up and down the workpiece 2 by using the mechanism 39 which moves up and down the carriage arm 22. In this case, since the carriage arms 22 can be individually or all simultaneously slightly expanded/contracted, the workpiece 2 held by each carriage arm 22 can be moved to any position in the horizontal direction within a movable range, and it can be moved up and down at each position.

In this embodiment, although the workpiece 2 is carried in from the workpiece supply portion 25, moved to a desired workpiece processing portion 23 and carried out from the workpiece discharge portion 26 by the carriage device 21. However, such operations may be relatively performed. That is, when a mechanism which horizontally moves the entire workpiece processing portions 23 in the radial pattern is provided, the workpiece 2 can be relatively moved to the workpiece processing portion 23 side without being moved in the horizontal direction. Further, if a mechanism which moves up and down the workpiece processing portions 23 is provided, the carriage arm 22 does not have to be moved up and down.

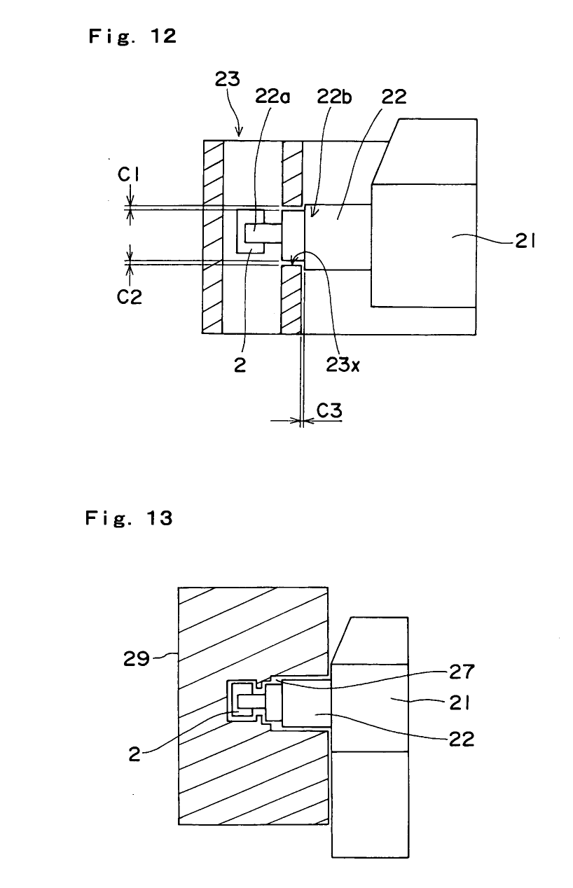

As shown in FIG. 12, the carriage arm 22 has a step-shaped base portion 22b. The base portion 22b having such a shape can narrow clearances of the insertion hole 23x of the workpiece processing portion 23 and prevent the cleansing liquid from splashing to the carriage device 21 side. For example, in this embodiment, radial clearances C1 and C2 between the carriage arm 22 and the insertion hole 23x and an axial clearance C3 are as shown in FIG. 12, narrowing these values so as not to obstruct the movement of the carriage arm 22 can further prevent the cleansing liquid from splashing.

Furthermore, if the carriage arm 22 can be cleansed together with the workpiece 2, the cleanliness of the carriage arm 22 in the vicinity of a position close to the workpiece 2 can be assured, which is preferable. In this case, although not shown in detail, at least one tank may be provided in a space extending from the workpiece supply portion 25 to the workpiece discharge portion 26, and this tank may be used to cleanse the carriage arm 22.

Partition walls 29 which partition each of the workpiece processing portions 23 are provided to the carriage portions 28 through which the workpiece 2 is actually carried between the workpiece processing portions 23 and the carriage device 21. Moreover, it is preferable that a carriage path 27 including a small gap through which only the carriage arm 22 and the workpiece 2 can pass is formed to each partition wall 29 as shown in, e.g., FIG. 13. When the gap through which the carriage arm 22 and the workpiece 2 pass is narrowed, contaminated outside air with a different cleanliness from the workpiece supply portion 25 can be prevented from entering and being mixed, and mixture of a different cleansing liquid of an adjacent workpiece processing portion 23 can be avoided. Additionally, an internal pressure can be gradually increased from the workpiece supply portion 25 toward the workpiece discharge portion 26, or a descending air current can be rectified.

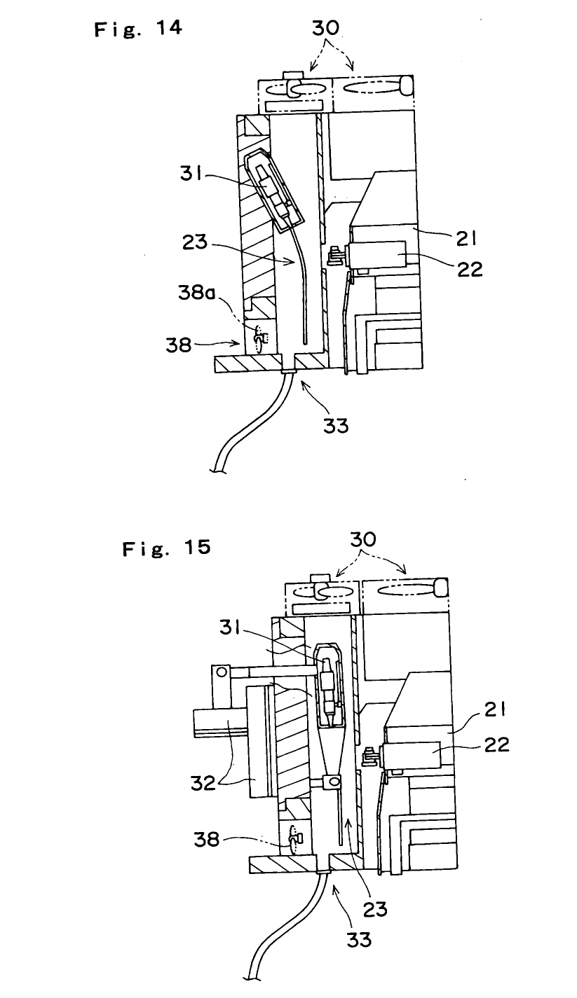

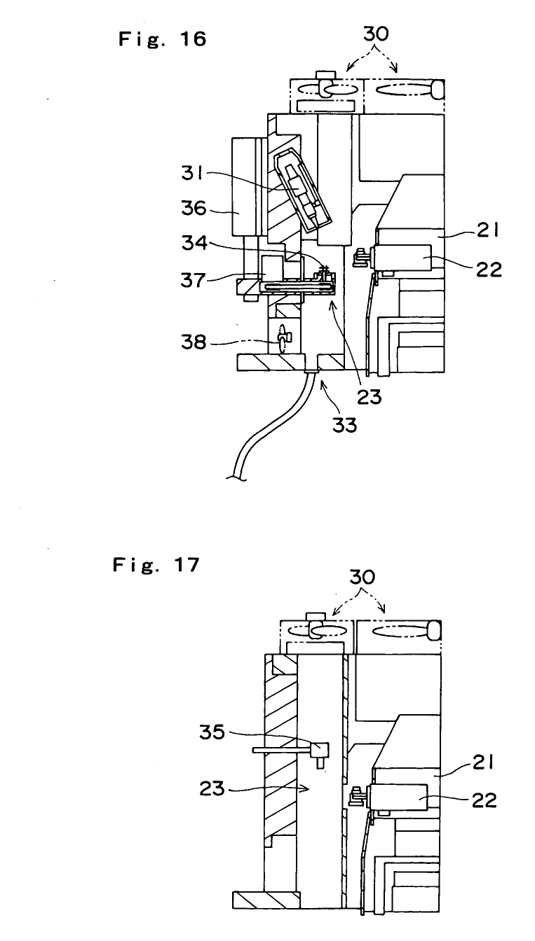

Further, the cleansing system 3c has a structure that the cleansing fluid flows down from the upper portion of each workpiece processing portions 23. Specifically, this structure includes a flowing water jet device 31 which generates ultrasonic waves and superpose them to the flowing water as shown in FIG. 14, and it belches out the ultrasonic flowing water to which ultrasonic waves are superposed as the cleansing fluid. To the lower portion of each workpiece processing portion 23 are provided a cleansing fluid discharge mechanism 33 formed of, e.g., a hose and a clean air exhaust hole 38 including a fan 38a or a slit 38b. The cleansing fluid is belched out in accordance with presence/absence of the workpiece 2. If a jet direction of the cleansing fluid can be appropriately changed, an angle at which the cleansing fluid is applied or a cleansing position can be freely varied, which is preferable. In the cleansing system 3c shown in FIG. 15, a direction of the flowing water jet device 31 is changed by utilizing a jet angle change mechanism 32 using a linear motor. Further, as shown in FIG. 16, an elevating mechanism 36 such as a linear motor which moves up and down the workpiece cleansing device 34 such as a cleansing brush provided inside the workpiece processing portion 23 or a rotation mechanism 37 such as a rotary motor may be provided. It is to be noted that the ultrasonic flowing water is exemplified here. However, besides this ultrasonic flowing water, a drying substitute liquid or drying hot air is included as a cleansing fluid applicable to the cleansing system 3c. FIG. 17 shows a workpiece processing portion 23 to which a clean hot air jet mechanism 35 is provided.

Furthermore, the cleansing system 3c performs the forward feed operation from the workpiece supply portion 25 to the workpiece discharge portion 26 at least two times. In this case, it is preferable to provide a function capable of switching settings of cleansing/drying functions of the workpiece processing portion 23 in accordance with, e.g., the first operation or the second and subsequent operations. As a result, the optimum cleansing can be carried out in accordance with a state of the workpiece 2 which differs depending on the first operation or the second and subsequent operations.

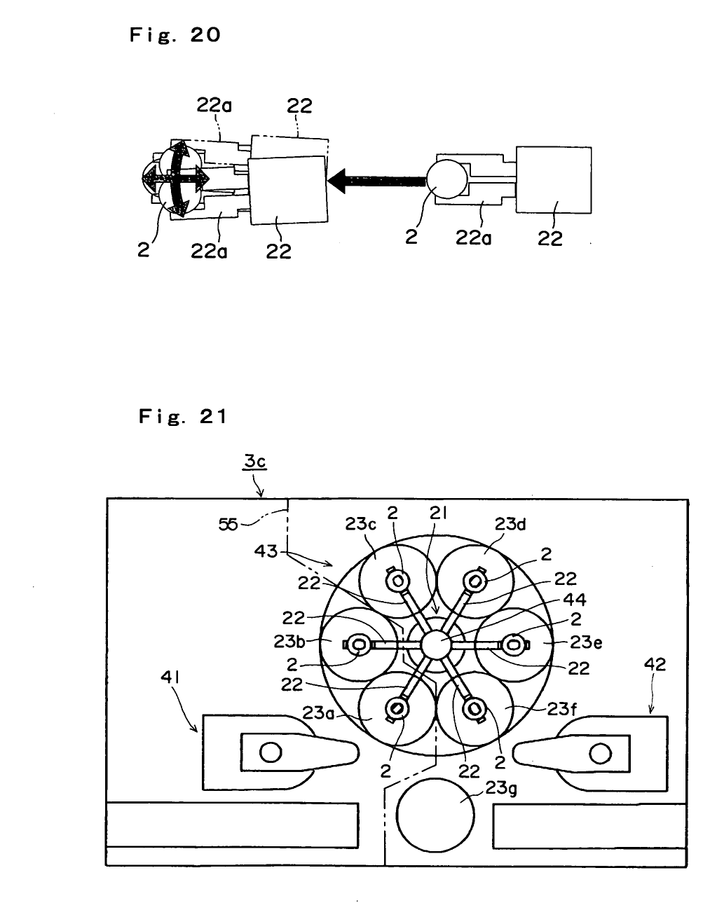

Moreover, the cleansing system 3c vibrates or slightly quivers the workpiece 2 in the workpiece processing portion 23 as shown in FIG. 20 by causing the drive portion 24 to perform minute operations such as rotating, expansion and contraction, and cleansing can be thereby evenly carried out with respect to the cleansing liquid jet and the workpiece cleansing device 34. As a result, when the ultrasonic flowing water cannot be sufficiently supplied to the workpiece 2 for example, the cleansing effect can be improved by finely vibrating or slightly quivering the workpiece 2.

It is to be noted that the above-described embodiment is just a preferred example according to the present invention, but the present invention is not restricted thereto, and various modifications can be carried out without departing from the scope of the invention. For example, when the equivalent mechanisms are used in not only cleansing but also a chemical process and only the functions of the workpiece processing portions 23 are changed, i.e., the functions such as “cleansing” and “drying” are replaced with functions such as “chemical processing”, “plating electrodeposition coating” and “etching”, it is possible to cope with a composite process in the clean environment.

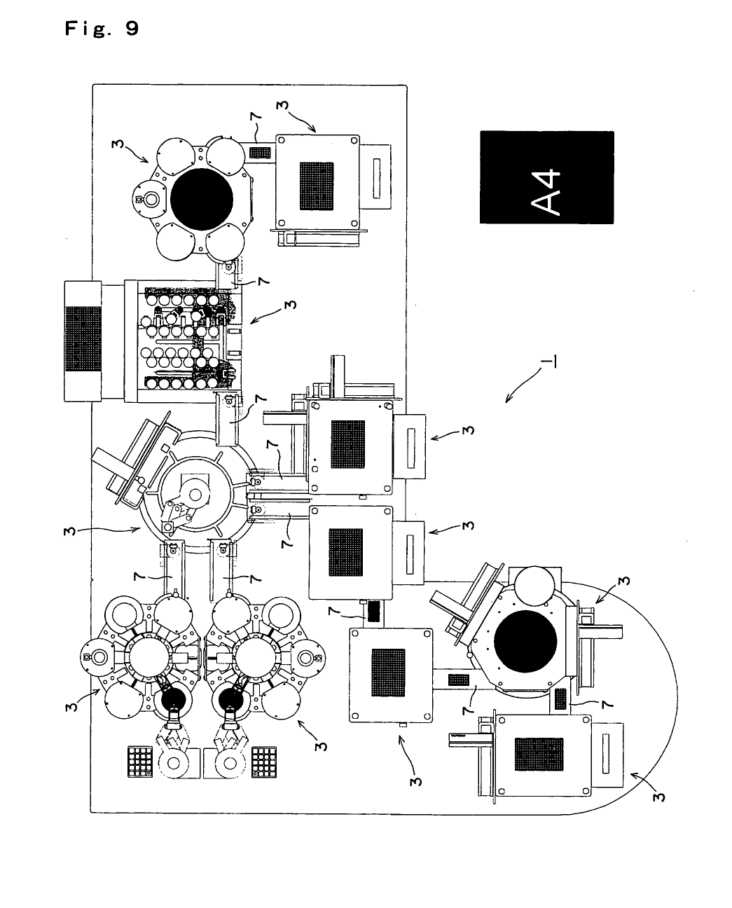

Moreover, although FIG. 1 shows an example of the production system 1 in this embodiment, the system conformation is not restricted thereto, and such a production system 1 as shown in FIG. 9 may be constituted by free arrangements and combinations of the mechanical devices 3 and the carriage tubes 7, and any other conformations can be of course adopted.

The cleansing system 3c according to this embodiment is of a so-called shower type which includes the flowing water jet device 31 and sprays the cleansing fluid to the workpiece 2 from the upper portion of each workpiece processing portion 23. However, when an attitude of the workpiece 2 when being held is maintained constant in cleansing and the workpiece 2 is cleansed, the cleansing mode is not restricted to the shower type. For example, a cleansing fluid such as a cleansing liquid, a rinsing or the like may be held in the tank of each workpiece processing portion 23, and the workpiece 2 may be soaked (immersed) and cleansed in this liquid. FIGS. 21 to 23 show an example of a cleansing system 3c performing such cleansing, and this system will now be described.

The cleansing system 3c shown in FIGS. 21 to 23 includes: a carry-in device 41 which carries in the workpiece 2, workpiece processing portions 23a to 23d as cleansing tanks in which the workpiece 2 is cleansed, workpiece processing portions 23e to 23g as drying tanks in which the cleansed workpiece 2 is dried, a carry-out device 42 which takes out the workpiece 2 from the workpiece processing portion 23g and carries it out, and a carriage device 21 which holds the workpiece 2 carried in by the carry-in device 41 and moves it into the workpiece processing portions 23a to 23d and the workpiece processing portions 23e to 23f (see FIG. 21). As shown in the drawings, in this example, there is provided a rotary type cleansing tank 43 in which the six workpiece processing portions 23a to 23f are arranged in a circular form at equal intervals, and the carriage device 21 arranged at the center of these portions holds the workpiece 2 and sequentially carries it to the respective workpiece processing portions 23a to 23f. Types of the six tanks to be adopted vary depending on classifications of the workpieces 2. However, in this example described herein, the first workpiece processing portion 23a is a cleansing tank (which will be referred to as a “cleansing tank 23a” hereinafter), the second to fourth workpiece processing portions 23b to 23d are cleansing tanks in which rinse is performed (which will be referred to as a “cleansing tank 23b”, a “cleansing tank 23c” and a “cleansing tank 23d” hereinafter), and the fifth and sixth workpiece processing portions 23e to 23f are air drying tanks in which draining is performed (which will be referred to as a “drying tank 23e” and a “drying tank 23f” hereinafter). Further, a workpiece processing portion 23g which is a vacuum drying tank (which will be referred to as a “drying tank 23g” hereinafter) is provided as a final drying tank in the vicinity of the rotary type cleansing tank 43. It is to be noted that the vacuum drying tank 23g is provided separately from the rotary type cleansing tank 43 in this embodiment, but the vacuum drying tank may be provided to the rotary type cleansing tank 43 depending on classifications of the workpiece 2.

The cleansing tank 23a is, e.g., a tank in which cleansing is carried out by utilizing ultrasonic waves, and removes contaminations which have adhered to the workpiece 2 soaked in water and a water-based cleansing agent in the tank. In place of water and the water-based cleansing agent, a semi-water-based cleansing agent or a non-water-based cleansing agent may be used as the cleansing agent in some cases. The cleansing tank 23b is a tank in which ultrasonic waves are utilized to perform coarse rinsing with respect to the workpiece 2 cleansed in the cleansing tank 23a. In this embodiment, as shown in the drawing, a partition member 55 is provided so as to pass between these cleansing tanks 23a and 23b and the other tanks 23c to 23f, and the cleansing tanks 23a and 23b are thereby partitioned from the other tanks 23c to 23f. Furthermore, the cleansing tank 23c is a tank in which secondary rinsing is performed by utilizing ultrasonic waves, and the cleansing tank 23d is a tank in which tertiary rinsing (final finishing rinsing) is carried out by utilizing ultrasonic waves. The drying tanks 23e and 23f are tanks in which the rinsed workpiece 2 is dried by spraying air thereto. Moreover, the drying tank 23g is a tank in which final drying of the workpiece 2 is effected by performing drawing air in the tank.

The carry-in device 41 passes to the carriage device 21 the workpiece 2 which has been carried to the front of the rotary type cleansing tank 43, and it is constituted of, e.g., a workpiece carry-in robot which holds and moves the workpiece 2 by an arm capable of rotating and linearly moving. The carry-out device 42 receives the dried workpiece 2 and mounts it onto the carriage device on the carry-out side, and it is constituted of, e.g., a workpiece carry-in robot which holds and moves the workpiece 2 by an arm capable of rotating and linearly moving as well as the carry-in device 41.

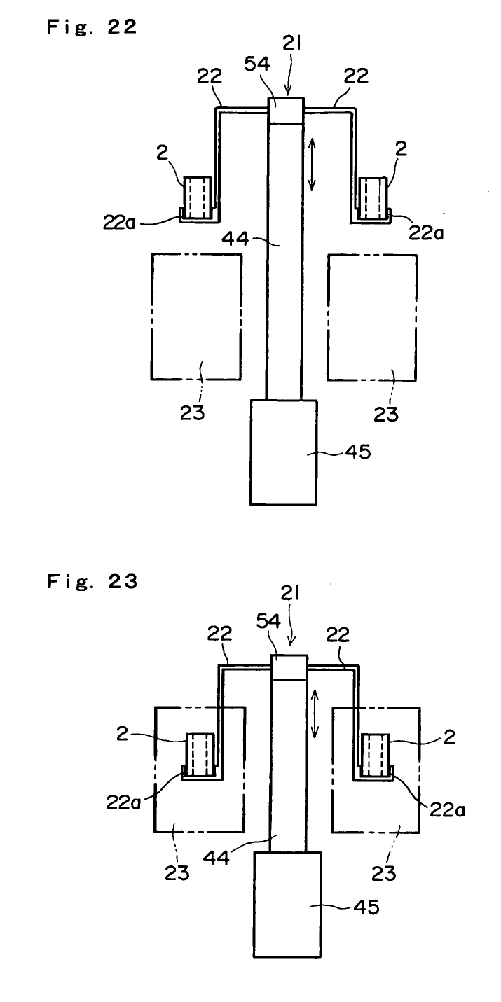

The carriage device 21 holds the carried-in workpiece 2 and sequentially moves it in the cleansing tanks 23a to 23d and the drying tanks 23e to 23f. For example, as shown in FIG. 21 in this example, the six carriage arms 22 are arranged on an arm support shaft 44 in a circular form at equal intervals. The arm support shaft 44 can move up and down at the central position of the respective tanks 23a to 23f (see FIGS. 22 and 23), and moves up and down the six cleansing arms 22 in the respective tanks 23a to 23f at the same time, thereby taking in/out the workpiece 2. The upward and downward movements of the arm support shaft 44 are performed by using an elevating device 45. The workpiece 2 is mounted on a carriage hand 22a which is a workpiece mount portion of the cleansing arm 22, and an attitude of the workpiece 2 when being held is maintained constant during cleansing. It is to be noted that one workpiece 2 is mounted on the carriage hand 22a in this embodiment, two or more workpieces 2 may be mounted as long as the attitude of the workpieces 2 when being held can be maintained constant during cleansing. Additionally, a rotation device 54 provided at the upper end of the arm support shaft 44 rotates the carriage arms 22. Further, in this embodiment, the workpiece 2 is mounted so as to increase a cleansing area as much as possible.

An elevating speed of the elevating device 45 can be controlled. Therefore, by lowering the elevating speed of the elevating device 45 when soaking the workpiece 2 in the cleansing liquid held in each workpiece processing portion 23, the workpiece 2 can be held in the carriage hand 22a in the stable state even when the workpiece 2 is soaked in the cleansing liquid.

Furthermore, when performing ultrasonic cleansing, by lowering the elevating speed of the elevating device 45 at a position where the ultrasonic waves are strong, or by temporarily stopping the elevating device 45, the further effective cleansing is enabled.

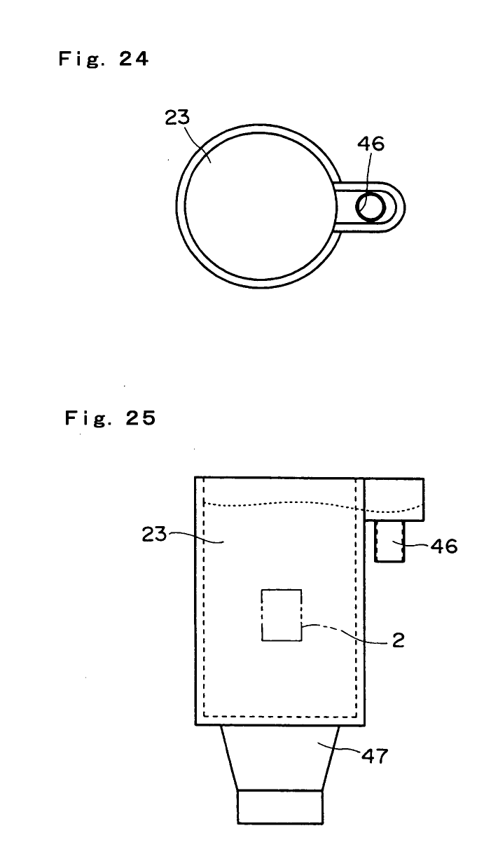

As each workpiece processing portion 23 which cleanses the workpiece 2, it is preferable to utilize a cleansing tank in which, e.g., ultrasonic cleansing is carried out. A workpiece processing portion 23 shown in FIGS. 24 and 25 includes an ultrasonic vibrator 47 constituted of, e.g., a piezoelectric element at the lower portion of the cleansing tank having a drain opening 46, and the ultrasonic vibrator 47 gives an ultrasonic energy to the cleansing liquid or the rinsing in the cleansing tank. The workpiece 2 soaked in this liquid can be cleansed by using a power of, e.g., cavitation generated from the ultrasonic waves.

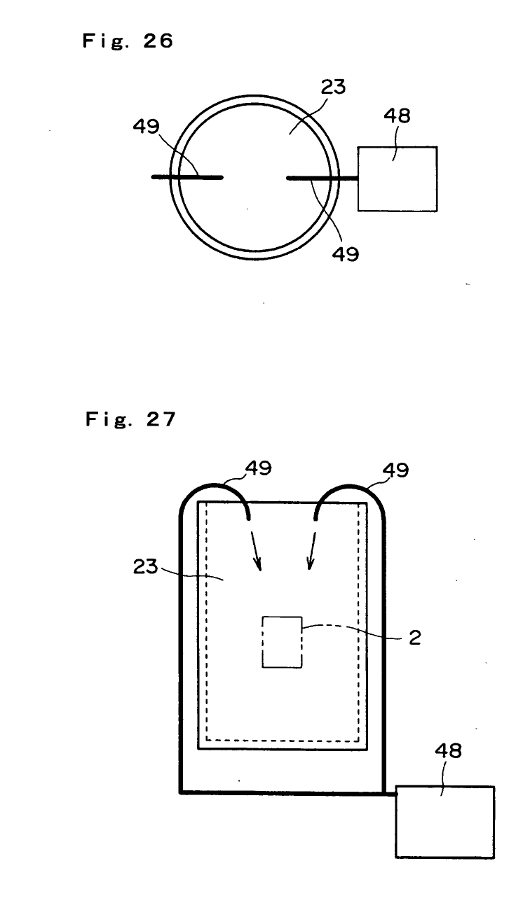

Moreover, as a workpiece processing portion 23 which cleanses the workpiece 2, it is preferable to utilize a drying tank in which, e.g., hot-air drying is effected. A workpiece processing portion 23 shown in FIGS. 26 and 27 includes a hot-air generator 48 and an air nozzle 49 capable of adjusting position in the tank, and blows out the liquid which has adhered to the workpiece 2 by spraying air from the hot-air generator 48 to the workpiece 2 and facilitates drying by warming the workpiece 2 with the hot air.

Since the air nozzle 49 has a structure that a flexible Teflon tube is attached to an end of, e.g., a non-illustrated stainless tube, a position at which drying air is applied can be readily changed by freely bending the tube. Like this embodiment, in a structure that each workpiece 2 is held in the carriage hand 22a, the drying air can be intensively applied to a part where the rinsing tends to remain, thereby assuredly drying the workpiece 2.

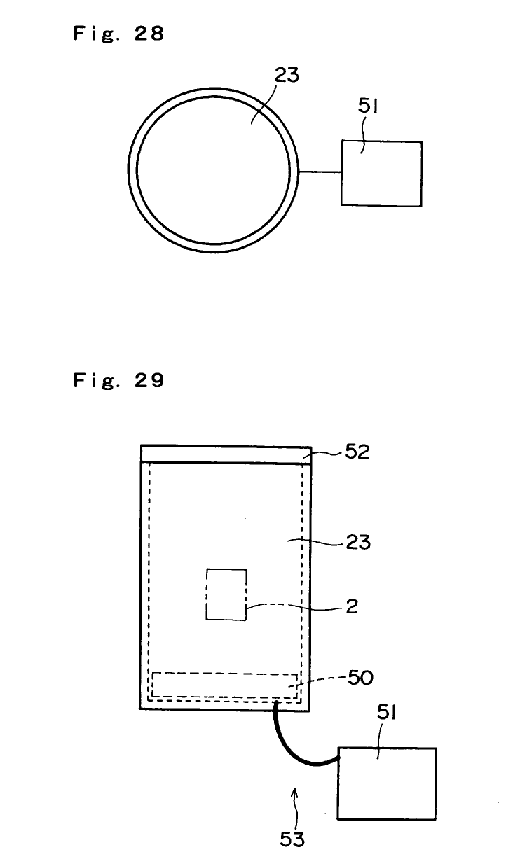

Additionally, as a workpiece processing portion 23 which cleanses the workpiece 2, it is preferable to utilize, e.g., a vacuum drying tank. A workpiece processing portion 23 shown in FIGS. 28 and 29 includes a heater 50 used to warm the workpiece 2 in the tank, and a pressure reducing mechanism 53 composed of, e.g., a vacuum pump 51 which performs drawing air of air in the tank and a lid 52 which hermetically seals the workpiece processing portion 23. An evaporating temperature of water which has adhered on the workpiece 2 is lowered by forming a vacuum or reducing a pressure in the drying tank, thereby facilitating complete drying.

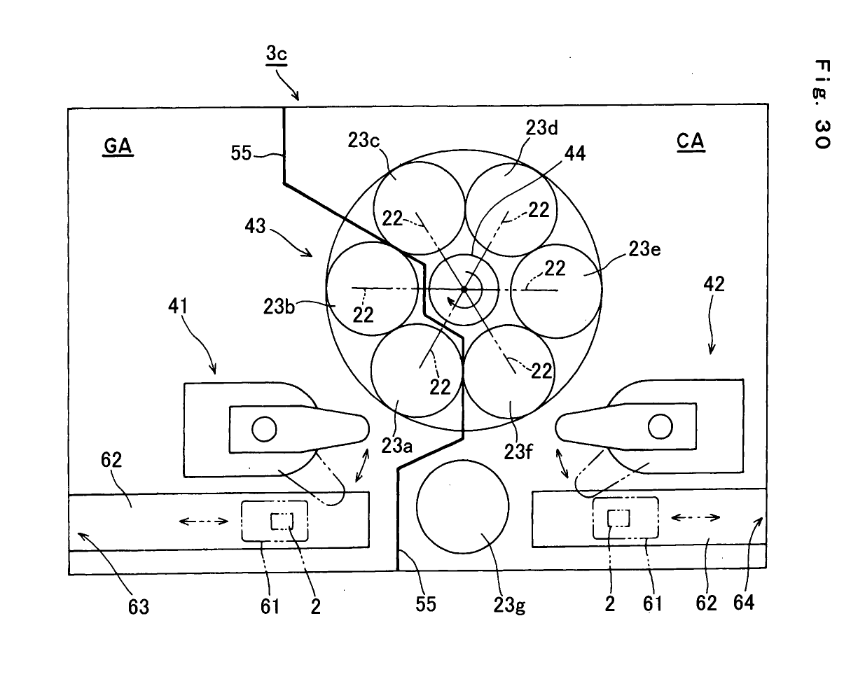

FIGS. 30 to 34 show an embodiment of an ultrasonic cleansing apparatus according to the present invention. This ultrasonic cleansing apparatus 59 removes contaminations by irradiating a workpiece 2 as a cleansing target with ultrasonic waves in a cleansing tank, and it is in charge of a cleansing operation to remove contaminations of the workpiece 2 in cleansing devices (which will be referred to as a “cleansing system” in the following description of the embodiment and denoted by reference numeral 3c) which perform cleansing/drying operations.

The cleansing system 3c in this embodiment includes a carry-in device 41 which carries in the workpiece 2, cleansing tanks 23a to 23d in which the workpiece 2 is cleansed, drying tanks 23e to 23g in which the cleansed workpiece 2 is dried, a carry-out device 42 which takes out the workpiece 2 from the drying tank 23g and carries it out, and carriage arms 22 which hold the workpiece 2 carried in by the carry-in device 41 and moves it into the cleansing tanks 23a to 23d and the drying tanks 23e to 23f, and this system is configured to be capable of individually cleansing the workpieces 2 (see FIG. 30). Furthermore, in this embodiment, a partition member 55 is set between the carry-in device 41 and the carry-out device 12, and a degree of cleanness in an area on the carry-out side (in this specification, this area is referred to as a “clean area” and denoted by reference character CA in FIG. 30) partitioned by this member is maintained. An area which is not the clean area (general environment area) is denoted by reference character GA.

Moreover, the cleansing system 3c according to this embodiment is an apparatus including a rotary type cleansing tank 43 in which six tanks are arranged in a circular form at equal intervals as shown in FIG. 30, and the carriage arms 22 arranged at the center of this apparatus hold the workpiece 2 and sequentially carry it to the respective tanks 23a to 23f. Types of the six tanks to be used vary depending on classifications of the workpieces 2 or whether an organic solvent is used as a cleansing agent. However, for example, in this embodiment, the first tank is a cleansing tank 23a, the second to fourth tanks are cleansing tanks 23b to 23d in which rinsing is performed, and the fifth and sixth tanks are air drying tanks 23e to 23f in which draining is carried out. Moreover, a vacuum drying tank 23g as a final drying tank is provided in the vicinity of the rotary type cleansing tank 43.

The carry-in device 41 passes to the carriage arm 22 the workpiece 2 carried in to the front of the rotary type cleansing tank 43, and it is constituted of, e.g., a workpiece carry-in robot which holds and moves the workpiece 2 by using an arm capable of rotating and linearly moving. In this embodiment, the workpiece 2 is brought into the general environment area from a workpiece carry-in opening 63 by a workpiece carriage pallet 61, and the carry-in device 41 moves the workpiece 2 to the cleansing tank 23a side. Although not explained in detail in this specification, the workpiece carriage pallet 61 is a cart which self-advances on a carriage rail 62 and carries the workpiece 2, and it enters the general environment area from the workpiece carry-in opening 63.

The carry-out device 42 receives the dried workpiece 2 and mounts it on the workpiece carriage pallet 61 on the carry-out side, and it is constituted of, e.g., a workpiece carry-in robot which holds and moves the workpiece 2 by using an arm capable of rotating and linearly moving as well as the carry-in device 41. Additionally, the workpiece carriage pallet 61 is formed of a cart which self-advances on the carriage rail 62 and carries the workpiece 2 as well as the device on the carry-in side, and it carries the workpiece 2 to the outside of the cleansing system 3c through the workpiece carry-out opening 64. In this embodiment, the workpiece 2 is received from the drying tank 23f by this carry-out device 42, it is taken in/out to/from the vacuum drying tank 23g where final drying is effected, and then the workpiece 2 is mounted on the workpiece carriage pallet 61.

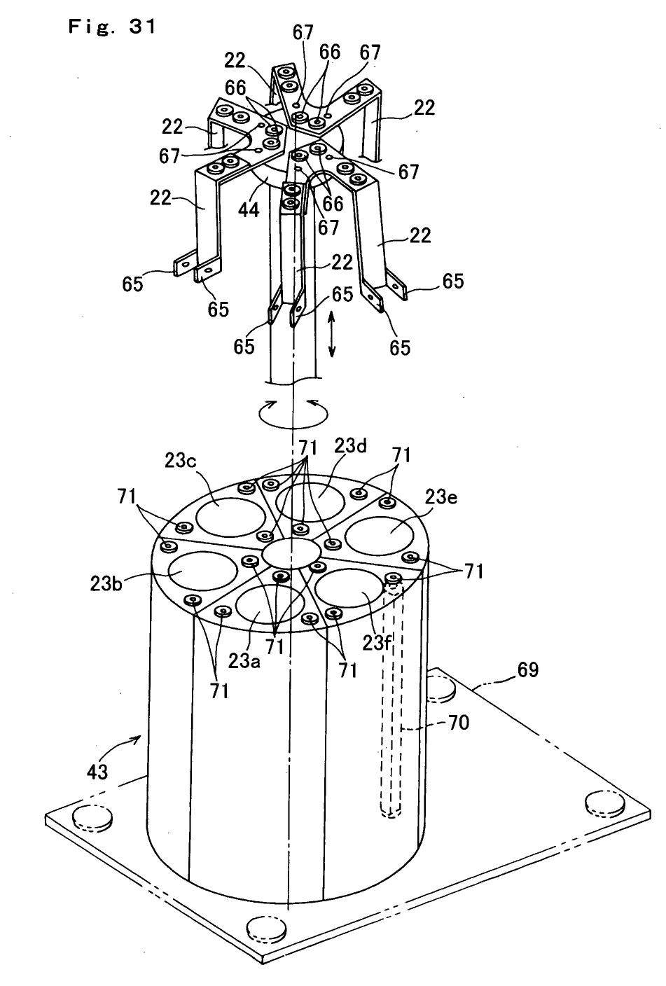

The carriage arms 22 are used to individually hold the workpiece 2 and sequentially move it in the cleansing tanks 23a to 23d and the drying tanks 23e to 23f. In this embodiment, as shown in FIG. 31, crank-shaped six carriage arms 22 are arranged on an arm support shaft 44 in a circular form at equal intervals. The arm support shaft 44 can rotate and elevate at the central position of the tanks 23a to 23f, moves up and down the six carriage arms 22 in the respective tanks 23a to 23f at the same time, and rotates to move them to the next tanks. An end portion of each carriage arm 22 may have a shape capable of directly mounting thereon and moving the workpiece 2, for example. However, in this embodiment, there is adopted a bifurcated support piece 65 to which a workpiece holding jig (not shown) for supporting the bottom surface of the workpiece 2 is attached. Further, although each carriage arm 22 may be configured to be individually attached on the arm support shaft 44, two carriage arms 22 form one unit and this unit is detachably disposed to the arm support shaft 44 by using attachment screws 66 in this embodiment (see FIG. 31). In this case, for example, when cleansing the workpieces 2 of a product concerning a large item small scale production, the units may be appropriately replaced or removed, for example. Each unit is positioned by positioning pins 67 on the arm support shaft 44.

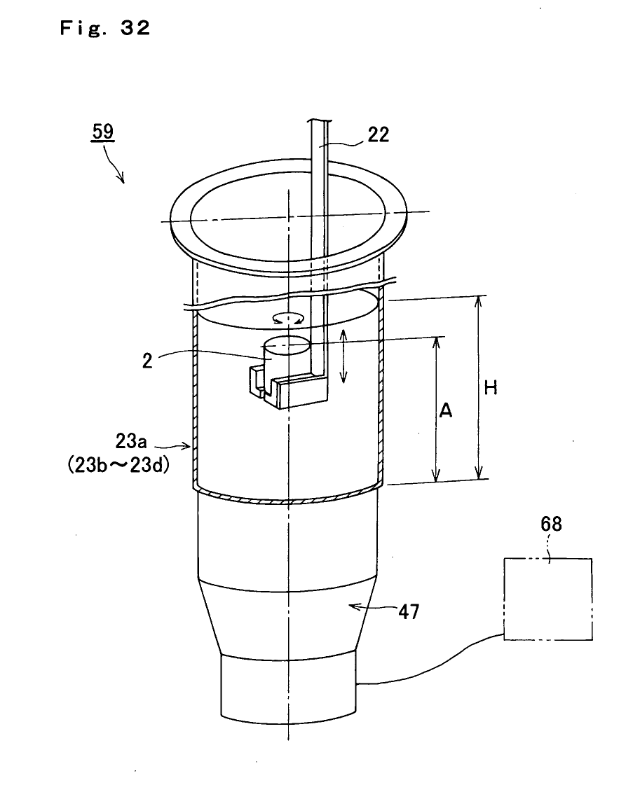

Furthermore, the cleansing tank 23a in which ultrasonic cleansing is performed (for example, in this embodiment, all of the cleansing tanks 23a to 23d correspond to this tank, but only the cleansing tank 23a is shown in FIG. 32) includes an ultrasonic cleansing apparatus 59 which removes contaminations by irradiating the workpiece 2 with ultrasonic waves. As shown in FIG. 32, this ultrasonic cleansing apparatus 59 includes an ultrasonic vibrator 47 on the bottom surface of the cleansing tank 23a, and it is provided so as to irradiate the workpiece 2 in the tank with ultrasonic waves. For example, the ultrasonic vibrator 47 according to this embodiment is constituted of a piezoelectric element fixed to the bottom surface of the cleansing tank 23a by bolting or by using an adhesive. As the piezoelectric element, a vibrator (bolting Langevin type vibrator) formed of, e.g., a BLT (bolting Langevin) is used. The bolting Langevin type vibrator is obtained by holding, e.g., two sheets of piezoelectric ceramics having holes by using a metal block and tightening them by using a bolt or a nut. This ultrasonic vibrator 47 is driven by an ultrasonic oscillator 68 and generates cavitations to the cleansing tank 23a based on ultrasonic waves (see FIG. 32).

The cleansing tank 23a in which ultrasonic cleansing is performed is generally formed of a stainless material. It is manufactured by welding if it is large in size, or it is manufactured by spinning processing or the like if it is small in size. Moreover, the cleansing tank 23a according to this embodiment is processed by electrolytic polishing in order to minimize contaminations (e.g., metal powder or ions) from the surface of the cleansing tank. This is also applied to the other cleansing tanks 23b to 23d.

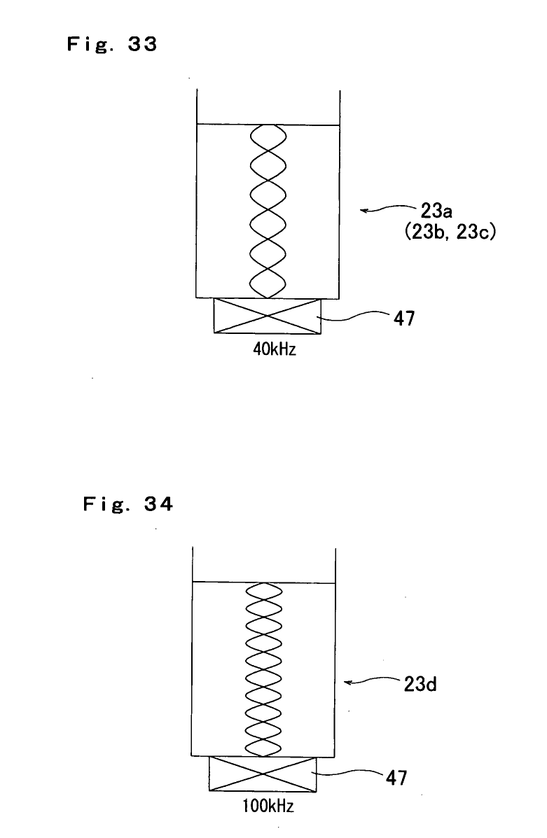

Ultrasonic waves in the ultrasonic cleansing apparatus 59 are suitable for strong contamination cleansing as their frequency is lower, and they are suitable for delicate contamination as their frequency is higher. A range of the frequency is, e.g., approximately 20 to 100 kHz. In the ultrasonic cleansing apparatus 59 according to this embodiment, ultrasonic waves having 40 kHz are used for each of the cleansing tanks 23a to 23c, and ultrasonic waves having 100 kHz are used for the cleansing tank 23d (see FIGS. 33 and 34). However, numeral values given herein are just an example, and it is needless to say that they can be appropriately changed in accordance with classifications of the workpieces 2.

Additionally, a holding tool part of each carriage arm 22 in this embodiment is formed to have small clearances with respect to the workpiece 2 so as not to come into contact with the peripheral surface of, e.g., a cylindrical workpiece 2 (see FIG. 32). The thus formed carriage arm 22 cannot prevent the workpiece 2 soaked in the cleansing liquid in the cleansing tank 23a from rotating upon receiving ultrasonic waves. Further, this carriage arm 22 can change an irradiation conformation. For example, a ratio of ultrasonic waves emitted from the lower portion or the periphery can be changed by varying a workpiece position (distance from the tank bottom is denoted by reference character A in FIG. 32) by moving up and down the held workpiece 2 in the cleansing tank 23a. Alternatively, a conformation of ultrasonic waves is changed at a position where the workpiece 2 is irradiated with the ultrasonic waves, e.g., an antinode part or a node part of the ultrasonic waves with which the workpiece 2 is irradiated. As described above, according to the ultrasonic cleansing apparatus 59 according to this embodiment, the carriage arm 22 is moved in the cleansing tank 23a and its position in the cleansing tank 23a is changed, thereby rotating the workpiece 2. Furthermore, a rotational direction and a rotational speed of the workpiece 2 can be controlled by appropriately changing a workpiece position (depth), and the cleansing effect can be advanced by, e.g., increasing a relative flow velocity of the cleansing liquid with respect to the workpiece 2. Moreover, the rotational direction and speed of the workpiece 2 can be further controlled by changing a frequency of the ultrasonic waves generated by the ultrasonic vibrator 47 in addition to such an operation of the carriage arm 22. That is, the frequency can be changed to a plurality of frequencies in the same tank by varying a resonance point on the ultrasonic vibrator 47 side, thereby controlling the rotational direction and the like of the workpiece 2. It is to be noted that reference character H in FIG. 32 denotes a depth of the cleansing liquid.

As described above, the rotating direction of the workpiece 2 in the tank irradiated with the ultrasonic waves is changed to a clockwise direction or a counterclockwise direction in accordance with a workpiece position (height) or a horizontal position and a frequency of the ultrasonic waves to be emitted, and the rotating speed of the workpiece 2 is also subtly changed. However, according to the ultrasonic cleansing apparatus 59 in this embodiment, the rotating direction and the rotating speed of the workpiece 2 can be controlled by appropriately changing a depth of the workpiece 2 in the cleansing tank 23a (23b to 23d) and an ultrasonic frequency. Therefore, the higher cleansing effect can be obtained. Incidentally, as to the frequency of the ultrasonic waves with which the workpiece is irradiated, the number of revolutions of the workpiece is reduced as the frequency is increased, but a timing to switch forward/backward rotations becomes fast. On the contrary, the number of revolutions of the workpiece is increased as the frequency is lowered, but the timing to switch forward/backward rotations becomes slow. Therefore, it is desirable to switch the rotating direction and the rotating speed of the workpiece 2 by utilizing this property. Furthermore, it is needless to say that the rotational direction and the rotational speed vary in accordance with a size and a shape of the workpiece 2.

It is to be noted that the respective tanks constituting the rotary type cleansing tank 43, i.e., the cleansing tanks 23a to 23d and the drying tanks 23e to 23f can be detachable with respect to the rotary type cleansing tank 43. Therefore, the respective tanks 23a to 23f in this embodiment can be readily meticulously cleaned when removed from the rotary type cleansing tank 43. The respective tanks 23a to 23f are positioned with the excellent reproducibility at predetermined positions of the rotary type cleansing tank 43 by using non-illustrated positioning pins or the like. For example, they are fixed at these predetermined positions by using three attachment members 70 per tank which are fixed on a base plate 69 and attachments 71 composed of three screws per tank fastened to the attachment members 70 (see FIG. 31). Each attachment member 70 is formed of, e.g., a vertical hexagonal columnar support piercing an attachment hole of each of the tanks 23a to 23f. When the respective tanks 23a to 23f are detachable in this manner, a cleansing content can be changed by providing, e.g., a different cleansing tank in place of the drying tank 23e. Alternatively, it is possible to remove one of the cleansing tanks (or the drying tanks) in order to assure an empty space, assemble a unit which chucks and inverts the workpiece 2 in this space and change a direction of the workpiece 2 in the middle of the cleansing process.

It is to be noted that the above-described embodiment is just a preferred example of the present invention, but the present invention is not restricted thereto, and various modifications can be carried out without departing from the scope of the invention. For example, only the rotating direction and the rotating speed of the workpiece 2 in the cleansing tank 23a (23b to 23d) are controlled in this embodiment. However, physical cleansing means may be combined with this in order to perform composite cleansing. For example, although not shown, by setting in the tank a brush or the like which comes into contact with the side surface of the workpiece 2 with a light resistance, physical cleansing of the side surface of the workpiece 2 rotating in the tank can be automatically effected.

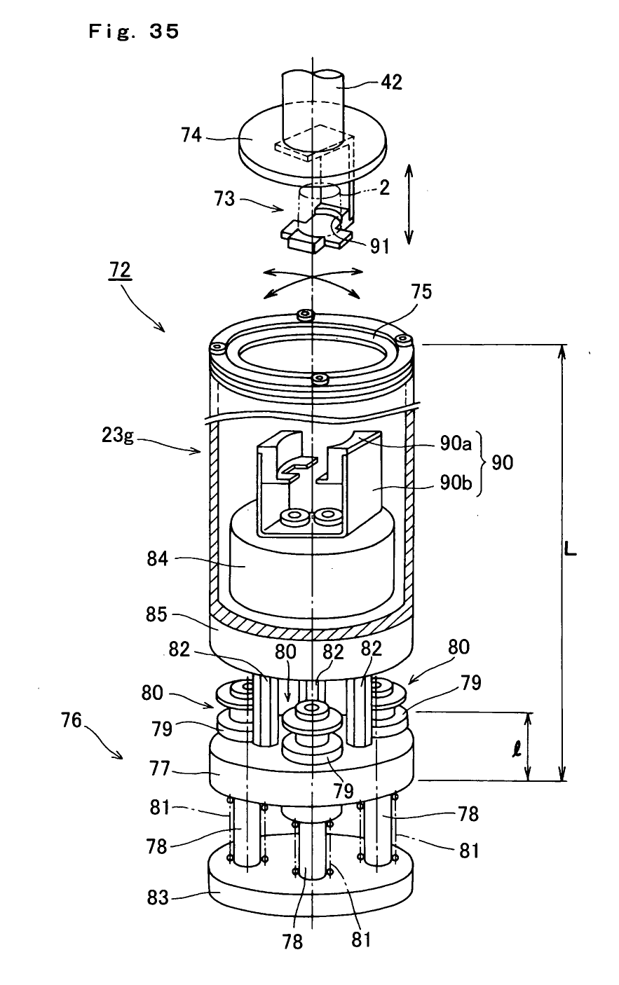

FIG. 35 illustrates an embodiment of a vacuum drying apparatus according to the present invention. This vacuum drying apparatus 72 is provided as a device in which a final drying operation in the cleansing system 3c is performed, and it moves the cleansed workpiece 2 into the vacuum drying tank 23g, draws a vacuum in the airtight state and dries the workpiece 2.

The carry-out device 42 includes a workpiece holding device 73 on the lower end side thereof, and it receives the dried workpiece 2 and mounts it on the workpiece carriage pallet 61 on the carry-out side. In this embodiment, a lid member 74 of the vacuum drying tank 23g is provided above a workpiece holding position of the workpiece holding device 73 of the carry-out device 42. It has a structure that the lid of the vacuum drying tank 23g is closed simultaneously when the workpiece 2 is inserted into the vacuum drying tank 23g. This lid member 74 has a shape matching with the vacuum drying tank 23g, e.g., a circular shape such as shown in FIG. 35, and it is provided in such a manner that it is appressed against the upper edge of the vacuum drying tank 23g and hermetically seals the vacuum drying tank 23g as soon as the workpiece 2 is moved down to a predetermined height (depth) in the tank. Furthermore, the lid member 74 according to this embodiment is fixed to and integrated with the workpiece holding device 73 of the carry-out device 42, and it does not relatively move up and down or tilt with respect to the workpiece holding device 73. A sealing member 75 formed of, e.g., a rubber O ring is provided on the bottom surface of the lid member 74 or the upper face of the vacuum drying tank 23g in order to maintain the airtight state between the lid member 74 and the vacuum drying tank 23g.

Further, the vacuum drying tank 23g according to this embodiment is supported at its lower portion by a support device 76 in such a manner that the tank itself can be inclined. Therefore, this vacuum drying tank 23g follows up an inclination of the lid member 74 when the lid member 74 is pressed against the top face of the vacuum drying tank 23g, and tilts as if it performs a swinging motion in accordance with the bottom surface of the lid member so as to be parallel with the lid member 74. Therefore, according to the vacuum drying apparatus 72 of this embodiment, the lid member 74 does not have to be strongly pressed against the vacuum drying tank 23g.

The support device 76 according to this embodiment is constituted of a movable support base 77 which supports the vacuum drying tank 23g, four (or three) support shafts 78 which support the movable support base 77 so as to be capable of elevating, ball bushing guides 79 provided between the support shafts 78 and the movable support base 77, stoppers 80 provided at upper ends of the support shafts 78 so as to come into contact with the top face of the movable support base 77, compression springs 81 which press the movable support base upwards, and others. The movable support base 77 is a discoid support base which supports the bottom portion of the vacuum drying tank 23g through, e.g., three columnar supports 82, and it is supported by the respective support shafts 78 through the respective ball bushing guides 79 so as to be capable of elevating and tilting. Each support shaft 78 extends in the vertical direction and is fixed on a base 83. The ball bushing guides 79 are set between the respective support shafts 78 and the movable support base 77 and function as bearings. They allow the movable support base 77 to elevate with respect to the vertical support shafts 78, and they also allow the movable support base 77 to tilt when the ball bushing guides with a short guide length are adopted in this embodiment. Furthermore, the compression springs 81 provided around the respective support shafts 78 upwardly push the movable support base 77 through the ball bushing guides 79. An upper stroke end of the movable support base 77 corresponds to a position where it comes into contact with the stoppers 80 at the upper ends of the support shafts 78. It is to be noted that an axial position of each stopper 80 can be adjusted by, e.g., a screw mechanism, and a position of the upper stroke end of the movable support base 77 can be thereby adjusted. It is to be noted that reference character L in FIG. 35 denotes a movable height and reference character I (shown in the cursive style in the drawing) designates a ball bushing guide length, respectively. As an example of each height, I=17 mm and L=110 mm are adopted, but they can be of course arbitrarily changed.

The support device 76 having the above-described configuration forms a movable structure that the vacuum drying tank 23g appears to be floating as shown in FIG. 35, and it usually positions the vacuum drying tank 23g to be parallel by the effects of the compression springs 81 and the stoppers 80. Moreover, when the lid member 74 is pressed against the top face of the vacuum drying tank 23g, the vacuum drying tank 23g follows up an inclination of the lid member 74 and tilts until it matches with the inclination of the lid member 74. Therefore, the inclination of the lid member 74 can match with that of the vacuum drying tank 23g by just lightly applying the lid member 74 on the top face of the vacuum drying tank 23g, and they can be appressed against each other, thereby maintaining a degree of vacuum. Incidentally, it is needless to say that the vacuum drying tank 23g does not tilt at all if the lid member 74 and the vacuum drying tank 23g are completely parallel with each other from the beginning.

Incidentally, it is preferable that the workpiece holding device 73 attached at the lower end of the carry-out device 42 is detachable. In such a case, the workpiece holding device 73 can be appropriately changed in accordance with a shape or the like of the workpiece 2 and the workpiece 2 can be further stably held, or cleansing and drying can be efficiently performed by narrowing a contact area with the workpiece 2 as small as possible. For example, in this embodiment, a jig of the workpiece holding device 73 has a cruciform such as shown in FIG. 35 and supports the bottom surface of the workpiece 2 in the vicinity of the center. Further, an arm portion of the workpiece holding device 73 has a shape which does not interfere with the workpiece 2, e.g., a channel shape retired rearward (see FIG. 35). A concave portion 91 matched with an outer peripheral shape of the workpiece 2 (e.g., a circular shape if the workpiece 2 has a cylindrical shape) may be provided on the holding surface of the workpiece holding device 73.

Furthermore, a workpiece mount base 90 which receives the workpiece 2 from the workpiece holding device 73 and mounts it thereon is provided in the tank of the vacuum drying tank 23g. This workpiece mount base 90 has a shape which does not interfere with the workpiece holding device 73. For example, it is a base having a channel shape when seen in plan which is constituted of a pair of right and left pieces opposed to each other as shown in FIG. 35 with respect to the above-described cruciform workpiece holding device 73, and it has a shape through which the workpiece holding device 73 can pass and elevate. Therefore, according to the vacuum drying apparatus 72 in this embodiment, the workpiece 2 held by the workpiece holding device 73 can be mounted onto the workpiece mount base 90 in this tank. When the workpiece 2 is mounted onto the workpiece mount base 90 in the tank in this manner, the rinsing attached to a contact area between the workpiece 2 and the workpiece holding device 73 and its periphery can be all readily evaporated.

Moreover, in this embodiment, a heater 84 which heats the workpiece mount base 90 is provided to the vacuum drying tank 23g. As a result, according to the vacuum drying apparatus 72 in this embodiment, the workpiece 2 mounted onto the workpiece mount base 90 from the workpiece holding device 73 can be heated by heat from the workpiece mount base 90, thereby obtaining a situation that evaporation can be further facilitated. In this case, it is needless to say that the workpiece mount base 90 is made of a material superior in heat transfer properties, e.g., a metal material. It is to be noted that the workpiece mount base 90 is formed of a jig 90a and a support base 90b which supports this jig 90a as shown in FIG. 35 in this embodiment. Additionally, by constituting the jig 90a so as to be capable of being attached/removed to/from the support base 90, the jig 90a can be appropriately changed in accordance with, e.g., shapes/dimensions or the like of the workpiece 2 and the workpiece holding device 73. A thermal insulating board 85 which prevents the columnar support 82 and its lower portion from being heated is provided to the lower portion of the heater 84. Incidentally, although not shown in particular, the workpiece 2 on the workpiece holding jig is mounted onto the workpiece mount base 90 by providing the workpiece mount base 90 having such a shape in each of the cleansing tanks 23a to 23d or the drying tanks 23e to 23f, in this embodiment.

According to the vacuum drying apparatus 72 having the above-described structure, the lid member 74 can be put on the vacuum drying tank 23g to form a sealed space simultaneously with insertion of the workpiece 2 into the vacuum drying tank 23g. Therefore, a device to put a lid on the vacuum drying tank 23g does not have to be additionally provided, and hence this is advantageous for a reduction in size and cost of the apparatus. Furthermore, it is not necessary to close or remove the lid member 74 when inserting/removing the workpiece 2 into/from the tank, and the time required for the operations can be thereby shortened.

Moreover, in case of this vacuum drying apparatus 72, when the lid member 74 is pressed against the vacuum drying tank 23g, the vacuum drying tank 23g tilts and automatically follows up the inclination of the lid member 74. Therefore, even if the lid member 74 and the vacuum drying tank 23g are not exactly parallel to each other, the automatic adjustment can be carried out and the lid member 74 can be appressed against the vacuum drying tank 23g. Additionally, when drawing air is performed in a state that the parallelism is assured in this manner, the lid member 74 is further drawn to the vacuum drying tank 23g and a degree of adhesion is increased, thus maintaining a degree of vacuum in the tank.

Further, in case of this embodiment, since the device which can tilt the vacuum drying tank 23g (i.e., the device constituted of the ball bushing guides 79, the stoppers 80, the compression springs 81 and others) is provided below the vacuum drying tank 23g, even if the dust is generated when the vacuum drying tank 23g tilts, a possibility that the dust enters the tank is very low. Furthermore, since the lid member 74 is fixed to the arm of the carry-out device 42, this part does not move and the dust is not generated. Therefore, the clean environment of the vacuum drying tank 23g can be maintained, and the dust can be prevented from adhering to the workpiece 2 when inserting or removing the workpiece 2 with respect to this vacuum drying tank 23g.

It is to be noted that the above-described embodiment is just a preferred example of the present invention, but the present invention is not restricted thereto, and various modifications can be carried out without departing from the scope of the invention. For example, in this embodiment, the vacuum drying tank 23g can tilt, and the lid member 74 fixed to the carry-out device 42 is pressed against the top face of the vacuum drying tank 23g. However, even if a structure that the lid member 74 can tilt is adopted in contradiction to the above, the same advantage as that of the vacuum drying apparatus 72 can be obtained. That is, even if the vacuum drying tank 23g is fixed so as not to tilt, the lid member 74 is attached to the carry-out device 42 so as to be capable of tilting and the lid member 74 can follow up the inclination of the vacuum drying tank 23g, the both members can be appressed against each other like this embodiment. However, it is desirable to use a structure that the movable part of the lid member 74 is completely covered and the dust generated when the lid member 74 tilted is prevented from falling onto the workpiece 2.

Moreover, in this embodiment, the compression springs 81 provided around the columnar supports 78 are exemplified as means for pushing the vacuum drying tank 23g (and the movable support base 77 which supports this tank) upwards and horizontally positioning it, but the present invention is not restricted thereto. For example, the vacuum drying tank 23g may be pushed by utilizing, e.g., the repulsive force of magnets. When the magnets are used in this manner, it can be considered that the dust which may be possibly generated in the tank is attracted to the magnets. However, performing the maintenance, e.g., periodically removing the attracted dust can eliminate the disadvantage, and this structure has no problem as impetus giving means.

Likewise, in this embodiment, the ball bushing guides 79 are exemplified as bearing means which is preferable to enable elevation and tilt of the movable support base 77 with respect to the columnar supports 78, but this is just a preferred example, and it is needless to say that means such as any other bearings which have the equivalent effects can be adopted.

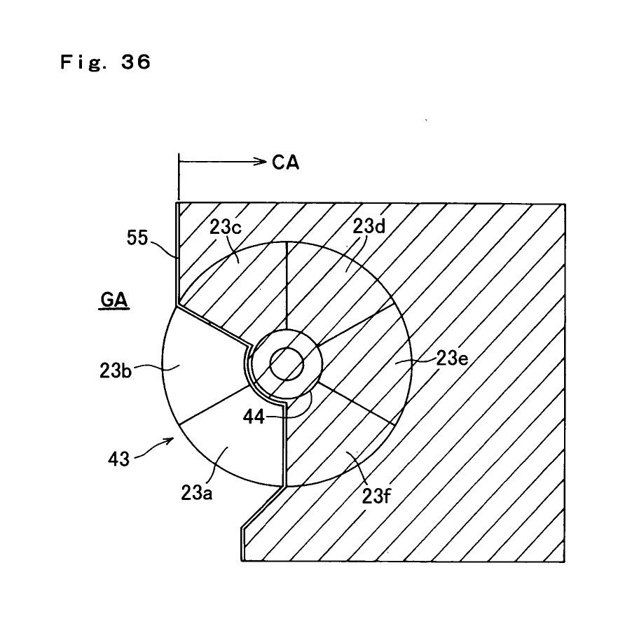

FIGS. 36 to 40 show an embodiment of a cleansing apparatus according to the present invention. In this embodiment, a partition member 55 is set between a carry-in device 41 and a carry-out device 42, and a degree of cleanness in an area CA on the carry-out side partitioned by this member is maintained.

That is, in this embodiment, as shown in the drawing, the partition member 55 is provided so as to pass between two cleansing tanks 23a and 23b and other tanks 23c to 23f, and the cleansing tanks 23a and 23b are partitioned from the other tanks 23c to 23f. The partition member 55 is formed of, e.g., a partition plate provided between the carry-in device 41 and the carry-out device 42, and partitions a predetermined area on the carry-out side in which at least a degree of cleanness should be maintained from an area (general environment area) on the carry-in side, thereby forming a local clean area. In this embodiment, in order to perform steps after the cleansing tank 23c in the clean environment, the tanks 23a and 23b side and the tanks 23c to 23g side are partitioned by the partition member 55, and the local clean area is provided on the carry-out side (see FIG. 36). However, this partitioning method is just an example. For instance, the drying tank 23d and the subsequent tanks may be determined as the clean area, and a partitioning position can be appropriately changed depending on an area which is determined as the clean area. Further, as shown in FIG. 36, the partition member 55 has a shape which is appropriately bent halfway so as to pass between the cleansing tank 23b and the cleansing tank 23c and between the cleansing tank 23a and the drying tank 23f so as to avoid an arm support shaft 44.

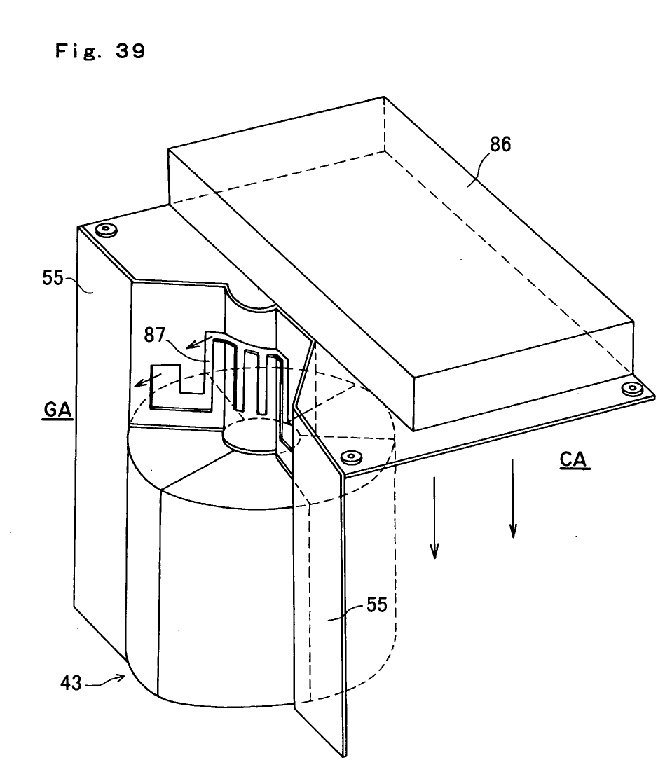

A clean air supply device 86 for supplying clean air which has passed through a filter (not shown) is provided above the clean area partitioned by the partition member 55 (see FIG. 39). The clean air supply device 86 is constituted of a fan motor unit which causes the clean air having passed through, e.g., an HEPA (High Efficiency Particulate Air) filter to flow downward to the clean area.

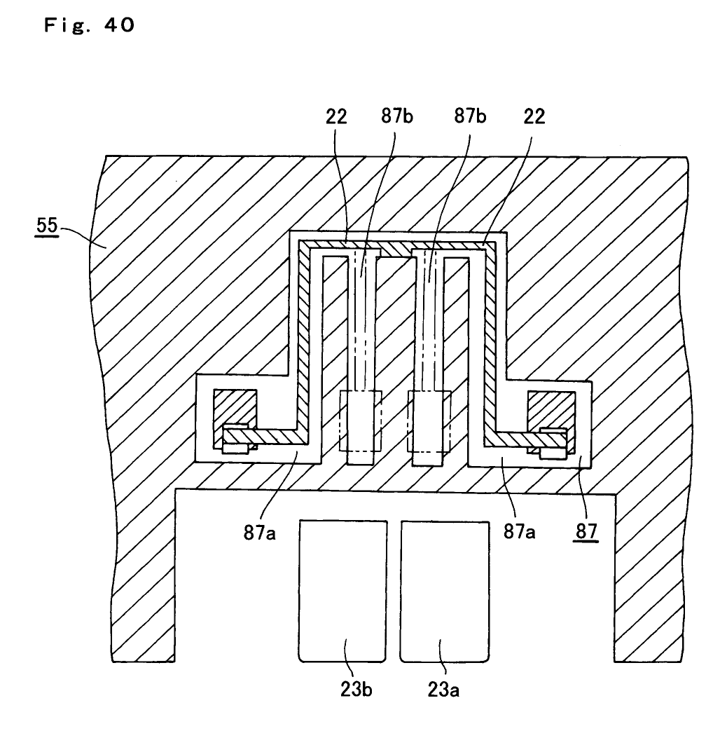

Furthermore, a notch 87 through which each carriage arm 22 which rotates and elevates can pass is formed to the partition member 55. That is, in the cleansing system 3c according to this embodiment that the tanks 23a and 23b are partitioned from the tanks 23c to 23g by the partition member 55, there is provided the notch 78 in order to pass the carriage arm 22 which moves from the cleansing tank 23b to the cleansing tank 23c and the carriage arm 22 which returns to the cleansing tank 23a from the drying tank 23f through the partition member 55. This notch 87 is not restricted to specific shapes or sizes in particular, but having a small notch area is preferable in view of maintaining a degree of cleanness in the clean area. In this case, a quantity of inflow air can be restrained when a superficial content of a communicating area from the clean area side to the general environment area side is suppressed, and the clean area can be thereby readily maintained to have a positive pressure. Therefore, the dust and the like can be easily prevented from entering the clean area. In this embodiment, as shown in FIG. 40, the notch 87 is constituted of symmetric crank-shaped notches 87a through which the rotating carriage arm 22 can pass and vertical groove-shaped notches 87b through which the carriage arm 22 can pass when moving down the workpiece 2 into the cleansing tanks 23a and 23b.

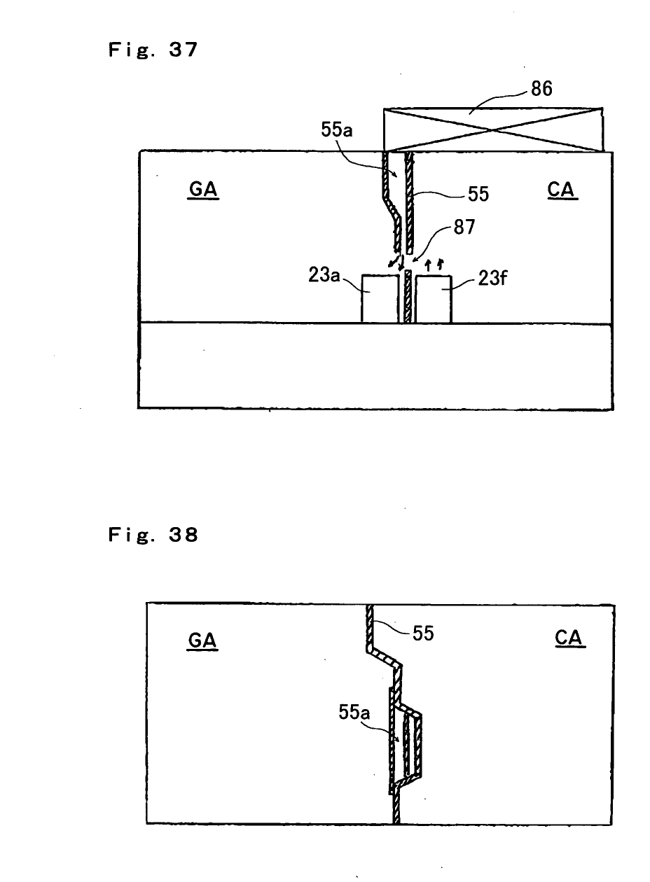

Moreover, it is preferable to form an air curtain by partially using a double structure to the partition member 55. For example, in this embodiment, as shown in FIGS. 37 and 38, the part of the partition member 55 provided between the cleansing tank 23a and the drying tank 23f has a double structure forming another flow path, and descending clean air which has flowed through this double structure portion 55a forms an air curtain in an open area of the notch 87. According to such a partition member 55, when an ascending air current of hot air is generated above, e.g., the drying tank 23f, movement of contaminated air into the clean area can be shut off without physically closing the notch 87. In this case, it is preferable that the double structure portion 55a has a tapered shape that a lower air outlet opening is narrower than an upper air intake opening. In this case, an air curtain with a fast flow velocity can be formed, and contaminated air can be further effectively shut off. It is to be noted that the double structure is used between the cleansing tank 23a and the drying tank 23f, but it is also preferable to use the double structure between the cleansing tank 23c and the cleansing tank 23d in addition to the above. In this case, when the cleansing tank 23c is used as a drying tank for example, contaminated air from the general environment area when spraying drying air to the workpiece 2 can be prevented from being pulled.

As described above, according to the cleansing system 3c of this embodiment, the partition member 55 partitions the cleansing/drying operation area into the general environment area and the clean area, and functions as a protective barrier which prevents the dust or the like from entering the clean area. Therefore, the cleansed/dried workpiece 2 can be maintained clean by keeping the cleanliness in the local clean area. Additionally, since the notch 87 is provided only at a part through which the carriage arm 22 passes, exhaust can be performed through this notch 87 and the clean area can be maintained to have a positive pressure.

It is to be noted that the above-described embodiment is just a preferred example of the present invention, but the present invention is not restricted thereto, and various modifications can be carried out without departing from the scope of the invention. For example, in this embodiment, the conformation that the partition member 55 is provided to the cleansing system 3c including a rotary type cleansing tank 43 is illustrated, but this is just an example, and the cleansing system 3c to which the present invention can be applied is not restricted to such a rotary type cleansing apparatus.

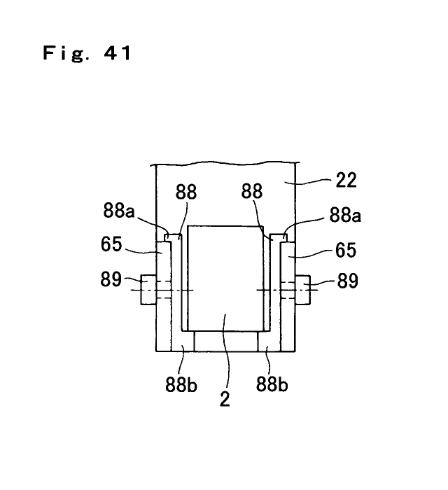

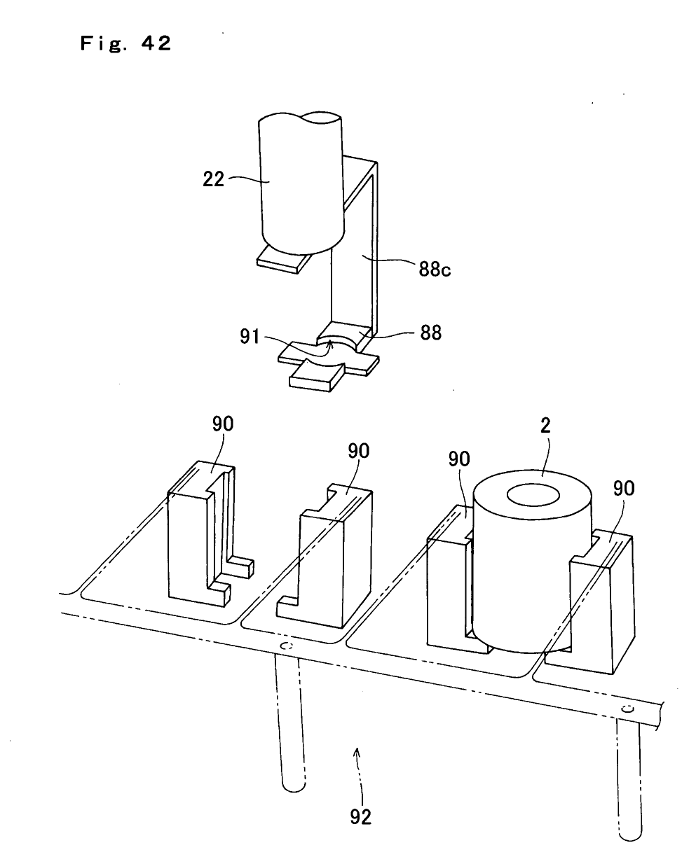

FIGS. 41 to 46 show another embodiment of the cleansing apparatus according to the present invention.

A carriage arm 22 of this cleansing system 3c holds a carried-in workpiece 2 and sequentially moves it into cleansing tanks 23a to 23d and drying tanks 23e to 23f. An end portion of each carriage arm 22 may have a shape on which the workpiece 2 can be directly mounted to be moved. In this embodiment, however, there is used a bifurcated support piece 65 to which workpiece holding jigs 88 which support the bottom surface of the workpiece 2 are attached.

Further, it is preferable that the workpiece holding jigs 88 attached to the end of each carriage arm 22 are detachable. In this case, the workpiece holding jigs 88 can be appropriately changed in accordance with a shape of the workpiece 2, and the workpiece 2 can be held in a more stable state. Furthermore, a contact area with the workpiece 2 can be reduced as much as possible, and cleansing and drying can be thereby efficiently carried out. For example, in this embodiment, the parallel bifurcated support piece 65 is provided at the lower end of the carriage arm 22 (see FIG. 31), and a pair of right and left workpiece holding jigs 88 are fixed to the support piece 65 by using screws 89 (see FIG. 41). The workpiece holding jig 88 is formed so as to support and lift up a part close to the outer periphery of the bottom surface of the workpiece 2 by using a support claw 88b which protrudes toward the inside. Furthermore, as shown in FIG. 41, a bent portion 88a which is bent toward the outside is provided at the upper edge of the workpiece holding jig 88, and the workpiece holding jig 88 can be fixed to the support piece 65 by using the single screw 89 when the bent portion 88a is hooked on the upper edge of the support piece 65.

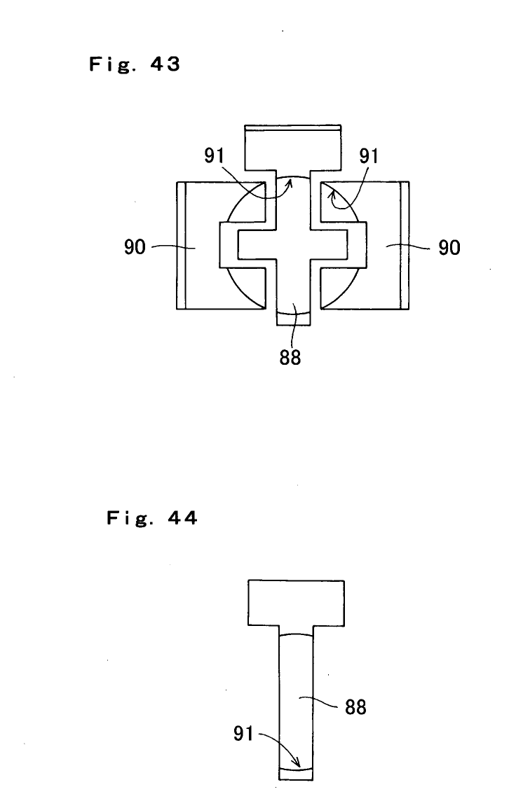

Although the pair of right and left workpiece holding jigs 88 shown in FIG. 41 support the part close to the outer periphery by the workpiece 2 by using the support claws 88b, the support position is not restricted thereto, and the workpiece holding jigs 88 may have a shape to support the bottom surface of the workpiece 2 in the vicinity of the center, e.g., a cruciform such as shown in FIG. 42 or 43, or an elongated rectangular shape such as shown in FIG. 44. In this case, the arm portion 88c of the workpiece holding jig 88 has a shape which does not interfere with the workpiece 2, e.g., a channel shape when seen from the side surface (see FIG. 42). As shown in FIG. 43 and the like, a concave portion 91 matching with an outer peripheral shape (e.g., a circular shape if the workpiece 2 has a cylindrical shape) is provided on the holding surface of the workpiece holding jig 88.

Further, the workpiece holding jig 88 and the workpiece mount base 90 on which the workpiece 2 is temporarily stocked are formed to have shapes which do not interfere with each other. For example, in FIGS. 42 and 43, the workpiece holding jig 88 has a cruciform and the workpiece mount base 90 has a pair of right and left channel shape as seen in plan, and hence the workpiece holding jig 88 can move up and down between the right and left pieces of the workpiece mount base 90. Therefore, as shown in FIG. 42, the workpiece 2 stocked on the workpiece mount base 90 can be supported from the lower side and moved so as to be lifted up by the workpiece holding jig 88. Although the workpiece mount base 90 is utilized in such a workpiece input jig 92 as shown in FIG. 42, the workpiece mount base 90 having such a shape is also provided in each of the cleansing tanks 23a to 23d or the drying tanks 23e to 23g and the workpiece 2 on the workpiece holding jig 88 is mounted onto the workpiece mount base 90 in this embodiment. For example, by mounting the workpiece 2 onto the workpiece mount base 90 from the workpiece holding jig 88 in the drying tank 23e, the rinsing which has adhered to the contact area between the workpiece 2 and the workpiece holding jig 88 and its periphery can be all readily evaporated. Incidentally, in view of evaporating all of the adherent water in the drying tanks 23e to 23g or sufficiently removing contaminations in the cleansing tanks 23a to 23d, it is preferable to reduce the contact area between the workpiece mount base 90 and the workpiece 2 as much as possible and increase a degree of exposure of the workpiece surface.

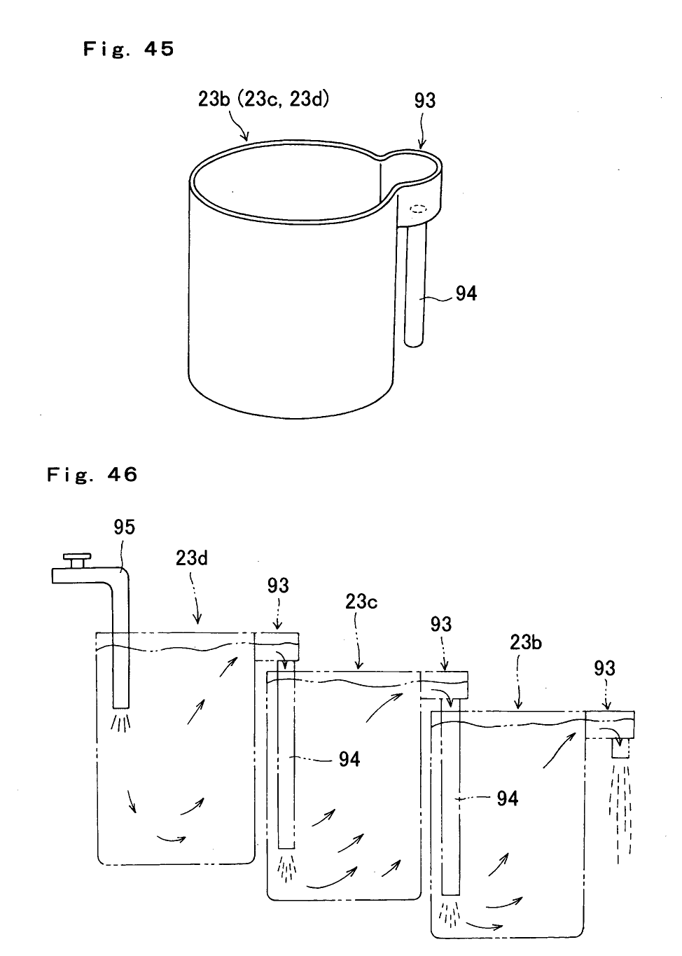

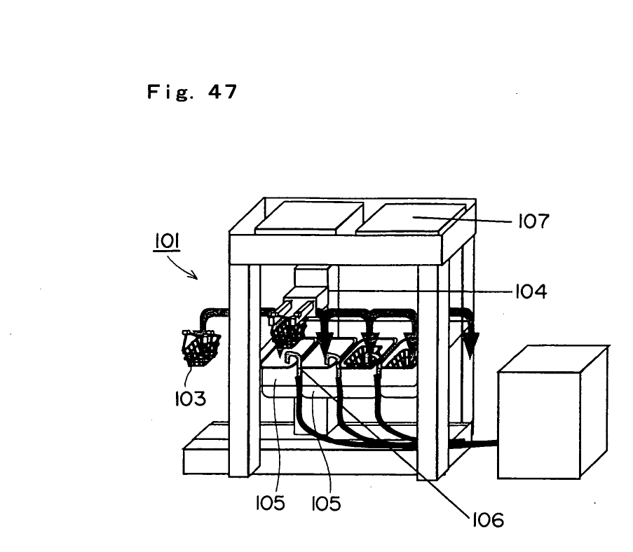

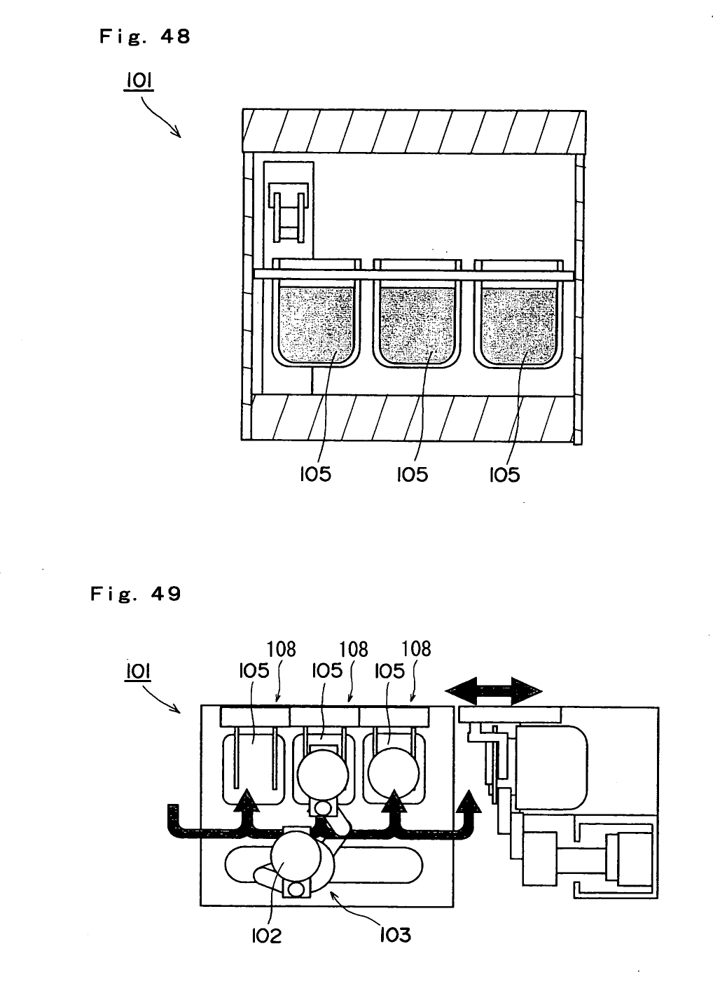

Furthermore, the respective tanks 23a to 23g are reduced in size in order to cleanse a small workpiece (e.g., a small component or the like used in a dynamic pressure bearing motor) in particular and have a structure advantageous to reduce a size of the entire cleansing system 3c. Moreover, a drain portion 93 and a drain pipe 94 are provided on the upper end side of each of the cleansing tanks 23b to 23d in which rinse is performed among the tanks 23a to 23g in order to drain the overflowed cleansing water (see FIG. 45). The drain portion 93 is a protrusion which protrudes from the upper end part of each of the cleansing tanks 23b to 23d toward the outer peripheral side, and the drain pipe 94 which is cernuous in the vertical direction is attached on the bottom surface of this protrusion. As shown in FIG. 46, in this embodiment, such cleansing tanks 23b to 23d are arranged at different heights in such a manner that the cleansing water flows from the cleansing tank 23d in which the final finishing rinse is carried out to the cleansing tank 23c and the cleansing tank 23b. Additionally, a water supply pipe 95 which supplies pure water with the high cleanliness to the cleansing tank 23d is provided on the upper side of the cleansing tank 23d, a drain pipe 94 of the cleansing tank 23d is inserted into the cleansing tank 23c, and a drain pipe 94 of the cleansing tank 23c is inserted into the cleansing tank 23b so that the cleansing water overflowed from the upper cleansing tank 23d side sequentially flows into the cleansing tank 23c and the cleansing tank 23b on the lower side. In this case, as the workpiece 2 cleansed in the cleansing tank 23a is rinsed in the cleansing tank 23b, the cleansing tank 23c and the cleansing tank 23d in the mentioned order, the cleanliness of the pure water is gradually increased (water becomes cleaner). Therefore, the cleanest pure water can be used in final rinse, and the cleansing water after rinse can be utilized in the cleansing tanks 23c and 23b on the lower side.

Further, in the cleansing system 3c according to this embodiment, since the respective tanks 23a to 23g including the cleansing tanks 23b to 23d are small tanks, the cleansing water in the cleansing tanks 23b to 23d is convected and overflows. That is, as shown in FIG. 46, the cleansing tank 23d, the cleansing tank 23c and the cleansing tank 23b are gradually arranged in such a manner that a water level is lowered in this order, and the water supply pipe 95 and the drain pipe 94 are provided so as to lead the cleansing water toward the tank bottom. Therefore, the cleansing water converts a positional energy into a kinetic energy and flows so as to be convected in the tank. Thus, contaminations and the like are hard to remain on the tank bottom. Therefore, a drain duct does not have to be provided on the tank bottom.

It is to be noted that the above-described embodiment is just a preferred example of the present invention, but the present invention is not restricted thereto, and various modifications can be carried out without departing from the scope of the invention.

1. A cleansing system comprising: a carriage device for receiving/passing a workpiece and carrying the workpiece to a work position for cleansing or drying the workpiece, the carriage device having carriage arms for individually grasping, mounting thereon or sucking the workpiece to carry it; a plurality of workpiece processing portions being arranged around the carriage device in a radial pattern; a drive portion for driving the carriage device; a workpiece supply portion for supplying the workpiece; and a workpiece discharge portion for discharging the workpiece.

2. The cleansing system according to claim 1, wherein the number of the carriage arms is not less than the number of workpiece processing portions.

3. The cleansing system according to claim 1, wherein the workpiece processing portion includes a cleansing tank or a drying tank for the workpiece.

4. The cleansing system according to claim 1, wherein a clean descending air current is caused to flow through entire the system including the workpiece processing portions, and a part where the descending air current can linearly flow down to a lower portion of the system is provided in a vicinity of the workpiece discharge portion after cleansing.

5. The cleansing system according to claim 1, wherein the cleansing system has a carriage portion to which the workpiece having been cleansed is carried, and a linear air current path is assured to a lowermost portion of the system in such a manner that a descending air current in the carriage portion can linearly flow down.

6. The cleansing system according to claim 1, wherein the carriage device inserts the workpiece into the workpiece processing portion in a horizontal direction by expanding/contracting the carriage arm.

7. The cleansing system according to claim 1, wherein the carriage arms can be individually or all simultaneously finely expanded/contracted.

8. The cleansing system according to claim 1, wherein the carriage device has a mechanism which moves up and down the carriage arms.

9. The cleansing system according to claim 1, wherein the workpiece processing portions can be individually removed, and an inner wall of the workpiece processing portion on the carriage device side can be manually cleaned.

10. The cleansing system according to claim 1, wherein the drive portion is provided to drive the carriage device to rotate or slightly expand/contract in the workpiece processing portion and perform even cleansing with respect to a workpiece cleansing device or a cleansing liquid jet.

11. The cleansing system according to claim 1, at least one tank is provided to the workpiece processing portion, a cleansing liquid used to cleanse the workpiece is held in the tank, and the cleansing system has a mechanism which gives ultrasonic waves to the cleansing liquid by an ultrasonic vibrator provided outside the tank.

12. The cleansing system according to claim 1, wherein an air nozzle is arranged to the workpiece processing portion, and draining and drying of the workpiece are performed by using air from the air nozzle.

13. The cleansing system according to claim 1, wherein the cleansing system has a workpiece processing portion other than the aforesaid workpiece processing portions, including a heater for warming the workpiece and a pressure reducing mechanism for reducing a pressure of the aforesaid workpiece processing portion.

14. An ultrasonic cleansing apparatus for removing contaminations by irradiating a workpiece in a cleansing tank with ultrasonic waves, wherein the workpiece is rotated by moving a cleansing arm having the workpiece mounted thereon in the cleansing tank and changing a position of the cleansing arm in the cleansing tank.

15. An ultrasonic cleansing apparatus for removing contaminations by irradiating a workpiece in a cleansing tank with ultrasonic waves, wherein a cleansing arm having the workpiece mounted thereon is moved into the cleansing tank, and the workpiece is rotated by changing a frequency of the ultrasonic waves.

16. An ultrasonic cleansing apparatus for removing contaminations by irradiating a workpiece in a cleansing tank with ultrasonic waves, wherein a rotational direction and a rotational speed of the workpiece are controlled by changing a depth of the workpiece in the cleansing tank and a frequency of the ultrasonic waves.

17. A vacuum drying apparatus for moving a cleansed workpiece into a vacuum drying tank and drying the workpiece by drawing air in a sealed state, wherein a lid member of the vacuum drying tank is provided above a workpiece holding position of a workpiece holding device which holds the workpiece and takes in/out the workpiece with respect to the vacuum drying tank, and the lid member of the vacuum drying tank is closed simultaneously with insertion of the workpiece into the vacuum drying tank.

18. The vacuum drying apparatus according to claim 17, wherein a support device for supporting the vacuum drying tank so as to be capable of tilting is provided, and the vacuum drying tank can follow up the lid member so as to be appressed against the lid member when the lid member is pressed against the vacuum drying tank.

19. The vacuum drying apparatus according to claim 17, wherein a workpiece mount base for receiving and mounting thereon the workpiece from the workpiece holding device is provided in the vacuum drying tank.

20. The vacuum drying apparatus according to claim 19, further includes a heater for heating the workpiece mount base.

21. A cleansing apparatus comprising: a carry-in device for carrying in a workpiece; cleansing tanks for cleansing the workpiece; drying tanks for drying the workpiece after cleansing; a carry-out device for taking out the workpiece from the drying tank and carrying out the workpiece; and a cleansing arm for holding the workpiece carried in by the carry-in device and moving the workpiece into the cleansing tanks and the drying tanks, wherein a partition member is set between a carry-in side area and a carry-out side area, and cleanliness in the partitioned carry-out side area can be thereby maintained.

22. The cleansing apparatus according to claim 21, wherein a notch through which the cleansing arm can pass is provided to the partition member.

23. The cleansing apparatus according to claim 21, wherein a clean air supply device for supplying clean air having passed through a filter is provided to an upper portion of a clean area on the carry-out side, and cleanliness in the clean area is held when the clean area maintains a state that it has a positive pressure as compared with a pressure in the carry-in side area.

24. A cleansing tank in which a workpiece is brought and cleansed, wherein a drain portion and a drain pipe which drain cleansing water are provided on an upper end side of the cleansing tank.

25. The cleansing tank according to claim 24, wherein a plurality of the cleansing tanks are arranged at different heights, the drain pipe of an upper cleansing tank is inserted into a lower cleansing tank, and cleansing water in the upper cleansing tank flows into the lower cleansing tank through the drain pipe.

26. The cleansing tank according to claim 24, wherein the cleansing tank has a mount base on which the workpiece is mounted in the tank.

27. A cleansing apparatus comprising: cleansing tanks defined in claim 26; drying tanks for drying a cleansed workpiece; a carry-in device for carrying in the workpiece; a discharge device for discharging the workpiece; and a cleansing arm for holding the carried-in workpiece, moving it in the cleansing tanks and the drying tanks, and moving it to the discharge device.

28. A drying tank for drying a cleansed workpiece, wherein the drying tank having a mount base for mounting a workpiece thereon in the tank.

29. A production system comprising: a plurality of mechanical devices having workpiece operation sections in which operations are carried out with respect to a workpiece; a device for maintaining the workpiece operation section in a clean atmosphere; a carriage device for moving a position of the workpiece in its workpiece operation section; an operation drive device for driving the carriage device, the operation drive device being provided outside the workpiece operation section; and carriage tubes which connect the workpiece operation sections of the respective mechanical devices with each other, and carry the workpiece from one mechanical device to another mechanical device, wherein one of the mechanical devices is a cleansing system defined in claim 1.
